(19) United States
(12) Patent Application Publication
(10) Pub. No.: US 2023/0229735 A1
(43) Pub. Date: Jul. 20, 2023

(54) TRAINING AND IMPLEMENTING MACHINE-LEARNING MODELS UTILIZING MODEL CONTAINER WORKFLOWS

(71) Applicant: Chime Financial, Inc., San Francisco, CA (US)

(72) Inventors: Akshay Jain, Boise, ID (US); Frank Teoh, Milpitas, CA (US); Greg Tobkin, San Francisco, CA (US); Michael Tompkins, San Francisco, CA (US); Peeyush Agarwal, Mountain View, CA (US); Sashidhar Guntury, Los Angeles, CA (US); Yunfan Zhong, Mountain View, CA (US)

(21) Appl. No.: 17/578,222

(22) Filed: Jan. 18, 2022

(51) Int. Cl. G06K 9/62; G06N 20/00

(52) U.S. Cl. CPC G06K 9/6257; G06N 20/00; G06K 9/6264

(57) ABSTRACT

The present disclosure relates to systems, non-transitory computer-readable media, and methods that implement a pre-defined model container workflow allowing computing devices to flexibly and efficiently define, train, deploy, and maintain machine-learning models. For instance, the disclosed systems can provide scaffolding and boilerplate code for machine-learning models. To illustrate, boilerplate code can include predetermined designs of base classes for common use cases like training, batch inference, etc. In addition, the scaffolding provides an opinionated directory structure for organizing code of a machine-learning model. Further, the disclosed systems can provide containerization and various tooling (e.g., command interface tooling, platform upgrade tooling, and model repository management tooling). Additionally, the disclosed systems can provide out of the box compatibility with one or more different compute instances for increased flexibility and cross-system integration.

### BACKGROUND

Machine-learning models have become increasingly important for myriad different computing environments and use-cases. For example, conventional systems utilize a variety of processes to train and deploy classification machine learning models, generative machine learning models, and/or predictive machine learning models to manage and/or distribute digital content across computer networks. Developing and maintaining such machine-learning models, particularly at-scale, can present a variety of technical challenges. To illustrate, data scientists often write computer code to define individual machine-learning model processes. These algorithms, however, are often specific to particular data scientists or teams and utilize a variety of non-standardized features (e.g., naming conventions, structural organization, etc.) with respect to code variables, inputs and outputs, classes, and/or functions. This approach can present significant challenges to system efficiency, accuracy, usability, and interpretability of associated code when developing or maintaining a machine-learning model.

For example, conventional systems often implement a number of duplicative, inaccurate, and inefficient machine learning processes, as data scientists establish independent protocols and algorithms. This can lead to a significant waste of time and computing resources (e.g., processing power and memory). Similarly, these inconsistent machine-learning model processes present challenges associated with hard-to-debug errors and inconsistencies across digital environments or software tools. Moreover, making modifications to portions of a machine-learning process can introduce errors across other algorithms or protocols, introducing additional inefficiencies and inaccuracies.

In addition, conventional systems are also inflexible. For example, conventional systems often utilize rigid approaches that have incompatibilities between training and implementation processes. Similarly, conventional systems are also inflexible in that they cannot interface with third-party interfaces or workflows. Furthermore, some conventional systems utilize end-to-end algorithms that fail to provide flexible approaches to analyze intermediate machine learning steps or processes. In addition, as mentioned above, it is often difficult to modify any portion of a machine learning algorithm without introducing substantial errors in another portion of the machine learning algorithm.

Moreover, deployment and productization introduce additional efficiency and flexibility problems in conventional systems. Indeed, deployment of machine-learning models includes various tasks such as establishing serving stacks and logging and monitoring of code errors. These model deployment tasks require maintenance and upgrades over time which requires significant time and computer resources, particularly in conventional systems with duplicative code without centralized management.

Some conventional systems utilize external notebooks to implement machine learning processes. These systems suffer from many of the same problems and introduce additional technical drawbacks. For example, external notebooks often include hidden states and introduce complications that are not readily identifiable. External notebooks are often confusing and dangerous unless each cell is run exactly once in-order. External notebooks make it difficult to follow sound engineering practices in that they often mix library and execution code, fail to track dependencies, and fail to provide unit tests and measure coverage. It is also difficult to write testable code, track test coverage, reproduce errors or perform other use tooling such as formatting and linting, static analysis, type checking, or security scans.

### BRIEF SUMMARY

This disclosure describes one or more embodiments of systems, non-transitory computer-readable media, and methods that solve one or more of the foregoing problems in the art or provide other benefits described herein by implementing a pre-defined model container workflow that allows computing devices to flexibly, accurately, and efficiently define, train, deploy, and maintain machine-learning models. For instance, the disclosed systems can provide scaffolding in a variety of pre-defined model containers that create a standardized development environment for completing different training or implementation tasks within a machine-learning model pipeline. To illustrate, the disclosed systems can generate and utilize pre-defined model containers with corresponding base class design for data generation, transformation, model parameter tuning, testing, statistical analysis, registration, and inference. The disclosed systems allow data scientists to run machine learning pipelines via local client devices while executing various containers independently so that machine learning tasks can be paused, tested, analyzed, fixed, and resumed between containers. In addition, the disclosed systems can provide an opinionated directory structure for organizing code of a machine-learning model while also providing efficient approaches to debugging (e.g., automatic output to failure files) and sharing of transformations and packages between training and inference protocols. Further, the disclosed systems can provide containerization and various tooling (e.g., command interface tooling, platform upgrade tooling, and model repository management tooling) while providing out of the box compatibility with one or more different compute instances (e.g., AMAZON SAGEMAKER®) for increased flexibility and cross-system integration. In sum, the disclosed systems can significantly improve the efficiency, flexibility, and accuracy of training and implementing machine learning models.

### BRIEF DESCRIPTION OF THE DRAWINGS

The detailed description provides one or more embodiments with additional specificity and detail through the use of the accompanying drawings, as briefly described below.

FIG. 1 illustrates a computing system environment for implementing a machine-learning platform system in accordance with one or more embodiments.

FIG. 2 illustrates a machine-learning platform system utilizing pre-defined model container workflows in accordance with one or more embodiments.

FIGS. 3A-3G illustrate a machine-learning platform system implementing a pre-defined model container workflow for training one or more machine-learning models in accordance with one or more embodiments.

FIGS. 4A-4D illustrate a machine-learning platform system implementing a pre-defined model container workflow for generating a prediction from a machine-learning model in accordance with one or more embodiments.

FIG. 5 illustrates a flowchart of a series of acts for training a machine-learning model in accordance with one or more embodiments.

FIG. 6 illustrates a block diagram of an example computing device for implementing one or more embodiments of the present disclosure.

FIG. 7 illustrates an example environment for an inter-network facilitation system in accordance with one or more embodiments.

### DETAILED DESCRIPTION

This disclosure describes one or more embodiments of a machine-learning platform system that provides a standardized development environment for implementing independent, pre-defined containerized portions of a machine-learning model pipeline. These machine-learning model pipelines can correspond to a variety of different types of pre-defined model container workflows—including training, inference, testing, model maintenance, and others. For example, one or more pre-defined model container workflows define a model structure such that implementing computing devices can locally run a particular pre-defined model container (e.g., as test run with a sample of data). Further, one or more pre-defined model container workflows define a model structure such that implementing computing devices can execute code within a pre-defined model container and subsequently pause and resume before executing code within another pre-defined model container. This independent structure and execution of model containers can facilitate faster, more efficient parameter tuning, iterations on bug fixes, etc.

In addition, pre-defined model containers can include computer code for performing one or more model tasks. Such model tasks may include reformatting for compatibility with compute instances, automatically outputting errors to a failure file, sharing transformations between training and inference pipelines, using consistent pip packages for training and inference, automatically retraining a model, or updating model containers for other machine-learning models. Advantageously, in certain implementations, the machine-learning platform system can automatically push container/workflow updates such that other machine-learning models built on or trained using the pre-defined model container workflow can implement the updated version going forward.

To illustrate, one example workflow includes a pre-defined model container workflow for training a machine-learning model. In one or more embodiments, the pre-defined model containers include computer-executable instructions that, when executed, perform discrete aspects of training a machine-learning model. For instance, a pre-defined model container workflow may include pre-defined model containers for data generation, data transformation, model training and parameter tuning, model evaluation, model registration, and/or statistics generation. In this example, the data generation model container prepares data to be used in model training and evaluation. The machine-learning platform system can define a variety of base classes to facilitate consistent analysis and management of information and objects throughout the machine learning pipeline. The data transformation model container shares data transformations between training workflows and inference/serving workflows. The training-tuning model container trains a machine-learning model. The evaluation model container evaluates a trained model by providing a machine-learning testing metric (e.g., for determining whether to implement the trained model). The model registration container registers the trained model with a model store, repository, or compute instance. The statistics generation model container generates statistics of the training data.

Another example workflow includes a pre-defined model container workflow for inference (e.g., real-time or batch inference). For instance, a pre-defined model container workflow includes a feature generation model container, a feature transformation model container, and an inference generation model container. The feature generation model container can identify and fetch candidate features (e.g., inference data features). The features transformation model container transforms inference data features to generate encoded features. The inference generation model container generates a prediction based on the encoded features. In one or more embodiments, the machine-learning platform system serves the prediction to model storage, third-party software applications, etc. as may be desired.

Just as container content can include various elements, the inputs and outputs of each model container can also include one or more different elements. For instance, the machine-learning platform system can provide a variety of different types of interfaces, entry points, and accepted inputs for the different model containers of a pre-defined model container workflow. To illustrate, in certain implementations, the machine-learning platform system utilizes graphical user interfaces (e.g., that prompt a user to provide a certain user input). Alternatively, in some embodiments, the machine-learning platform system implements placeholder elements for users (e.g., data scientists) to insert a portion of code. Additionally, the machine-learning platform system can configure pre-defined model containers to generate a variety of outputs (e.g., in desired formats, at predetermined storage locations, etc.).

As mentioned above, the machine-learning platform system can provide a number of technical advantages over conventional machine-learning development systems. For example, the machine-learning platform system can improve system flexibility in a number of different ways by utilizing a pre-defined model container workflow with pre-defined model containers. To illustrate, the pre-defined model containers are independently executable such that executed jobs can start, pause, and resume at any point along the pre-defined model container workflow. This runtime flexibility can provide more flexible parameter tuning, iterations on bug fixes, and the like. In addition, improved system flexibility can include the machine-learning platform system executing a pre-defined model container workflow on a local client device or on a predetermined compute instance (e.g., a third-party server). As another example, the machine-learning platform system can improve system flexibility by configuring digital communications between workflows (e.g., sharing transformations between pre-defined model container workflows for training and inference).

Still further, the machine-learning platform system can improve system flexibility by integrating additional or alternative pre-defined model containers in a pre-defined model container workflow. For example, the machine-learning platform system can implement a new training data generator container based on feature store data without making changes to a training container. Similarly, the machine-learning platform system can swap out, rewrite, and/or upgrade pre-defined model containers in a pre-defined model container workflow to meet scalability and other model requirements without having to change other platform components. This modularity or independence of pre-defined model containers can also help prevent breaking requirements of other pre-defined model containers in a pre-defined model container workflow.

In at least some embodiments, the machine-learning platform system can improve execution speed by utilizing pre-defined model containers that are independently executable. For example, the machine-learning platform system can execute a pre-defined model container with fewer dependencies, thereby decreasing execution time. For example, the machine-learning platform system can execute one or more pre-defined model containers in parallel.

Additionally, the machine-learning platform system can enhance user workflow and/or user interfaces by providing an opinionated framework via a pre-defined model container workflow. For example, the machine-learning platform system provides user interfaces that guide the user in building out a code-based development path (e.g., via interactive prompts or placeholder prompts). Accordingly, the machine-learning platform system can streamline user inputs by enforcing a predetermined model architecture, convention, or best practice through the pre-defined model container workflow.

As a further technical advantage, the machine-learning platform system can improve user interpretability by providing an opinionated framework via a pre-defined model container workflow. For example, the machine-learning platform system can provide pre-defined model container workflows that define a codebase that is more predictable, more consistent, and easier for users to understand. With improved interpretability, the machine-learning platform system can improve efficiency of executions, training iterations, etc. to correspondingly reduce computer resource consumption.

In addition, the machine-learning platform system can improve system compatibility with one or more different compute instances. For example, the machine-learning platform system provides a pre-defined model container workflow that is configured for execution on one or more different compute instances (e.g., AMAZON SAGEMAKER®). Indeed, the pre-defined model container workflows can include training endpoints, serving endpoints, ping endpoints, invocation endpoints, data preparation entry points, etc. such that one or more different compute instances can execute a pre-defined model container workflow without additional user interaction to impart compatibility. For instance, the pre-defined model container workflow can include a docker image format (comprising the pre-defined model containers) ready for execution on one or more different compute instances.

Furthermore, the machine-learning platform system provides a number of improvements relative to conventional systems that utilize external notebooks. In particular, by generating one or more workflows with pre-defined model containers, the machine-learning platform system can share code that is common across models, introduce structure and modularity, and automatically perform logging, monitoring, and error handling. For example, a training base class writes errors to error files appropriately or logs error to a rollbar. Similarly, an inference base class can parse HTTP requests, read data appropriately and pass to a model inference function. Moreover, machine-learning platform system allows for sharing of code across train and inference or batch and real-time inference while providing an easy approach to programmatically specify model parameters and data paths. The machine-learning platform system also provides a containerization approach that packages code and dependencies within an image, brings reproducibility to model code and pipelines, and allows for efficient assistance in resolving problems for platform engineers. The machine-learning platform system also provides for improved code hygiene and accuracy by implementing test coverage, security scans, linting and formatting,

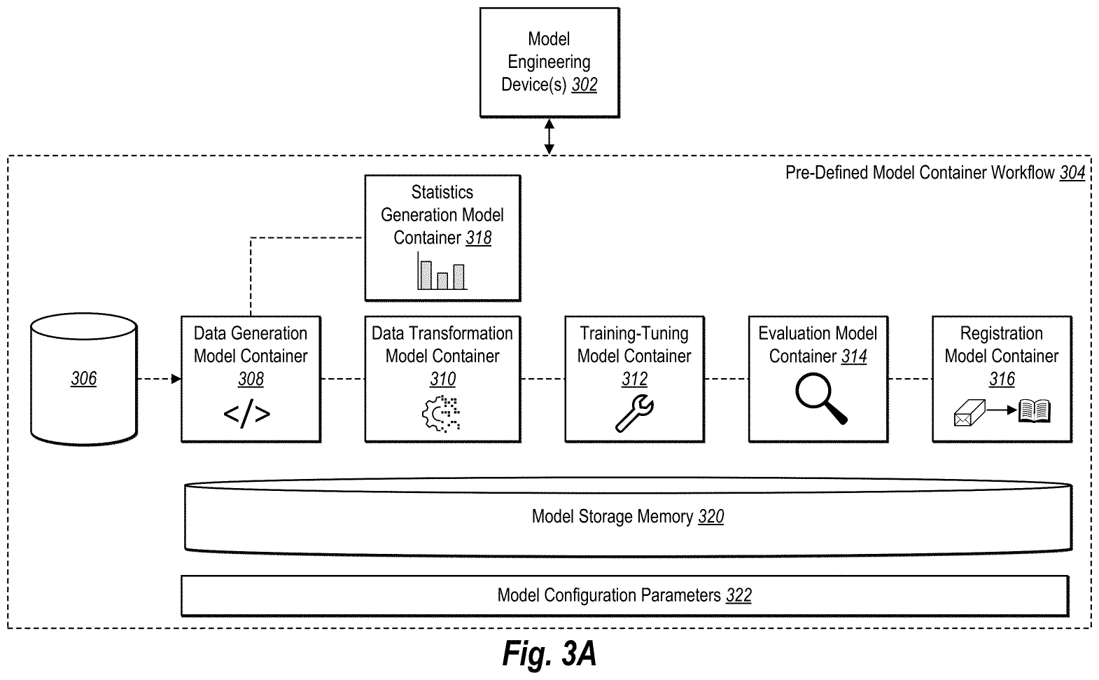

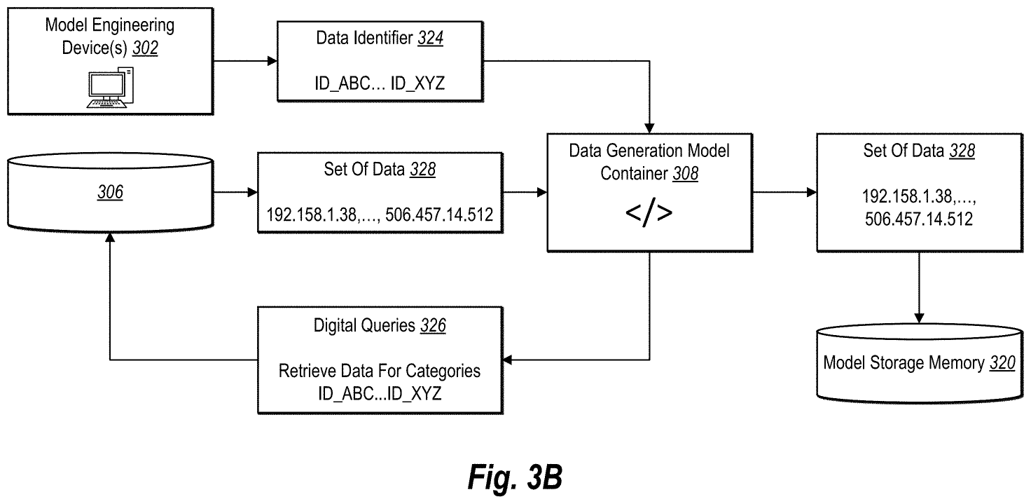

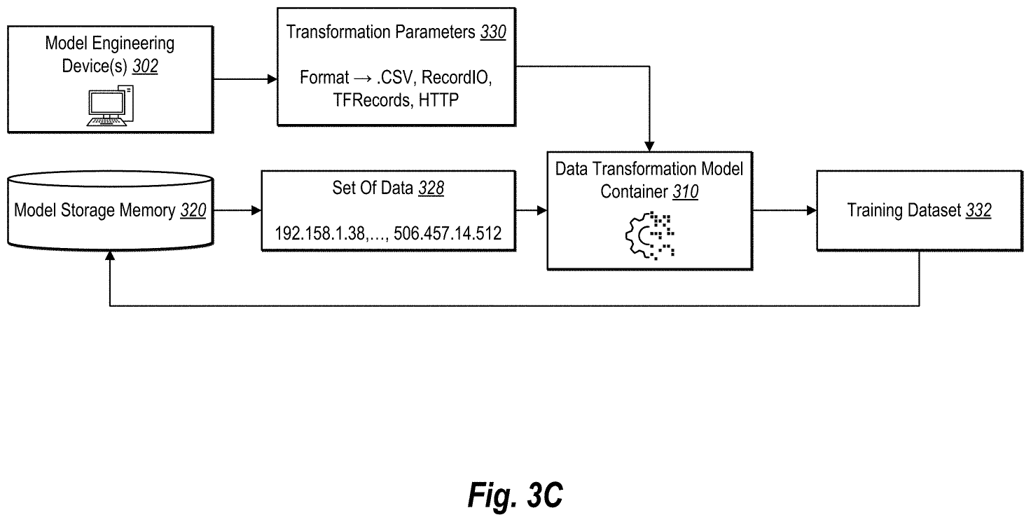

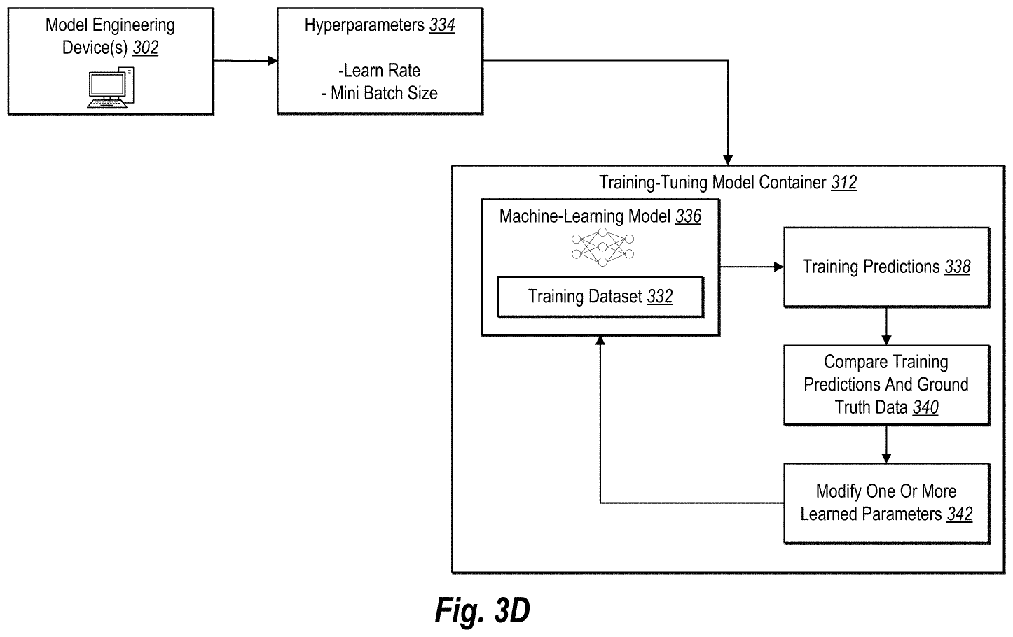

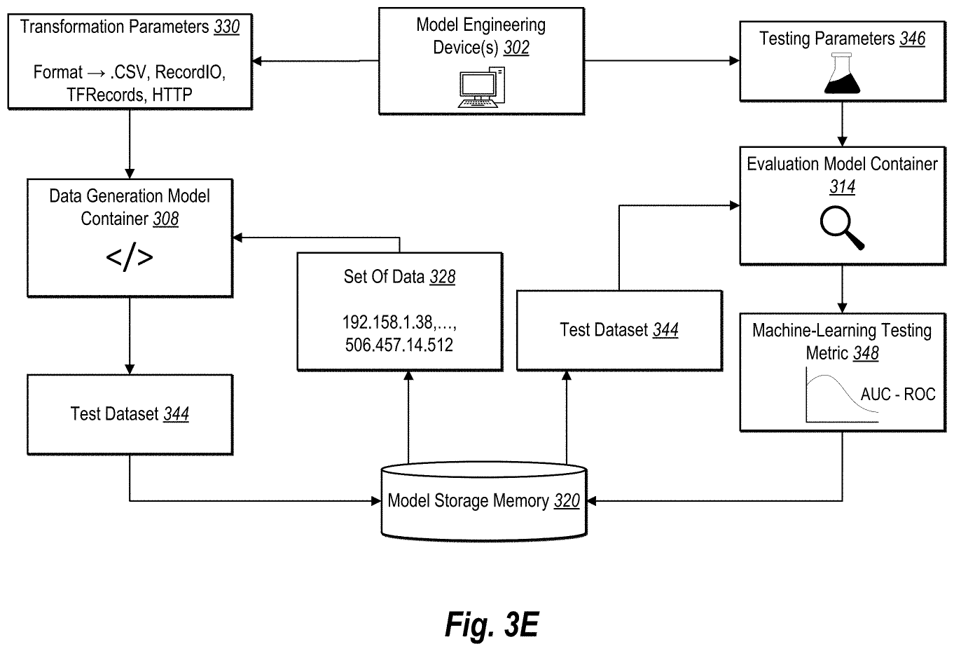

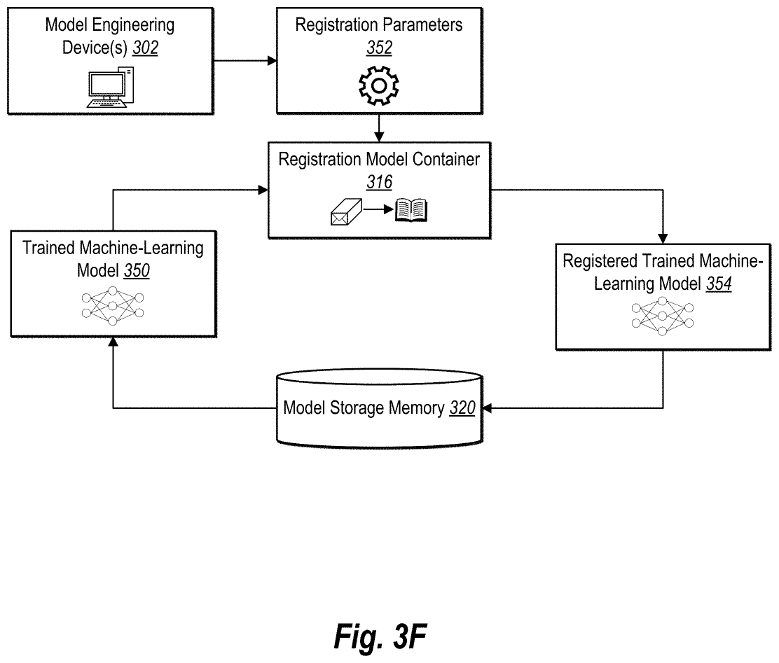

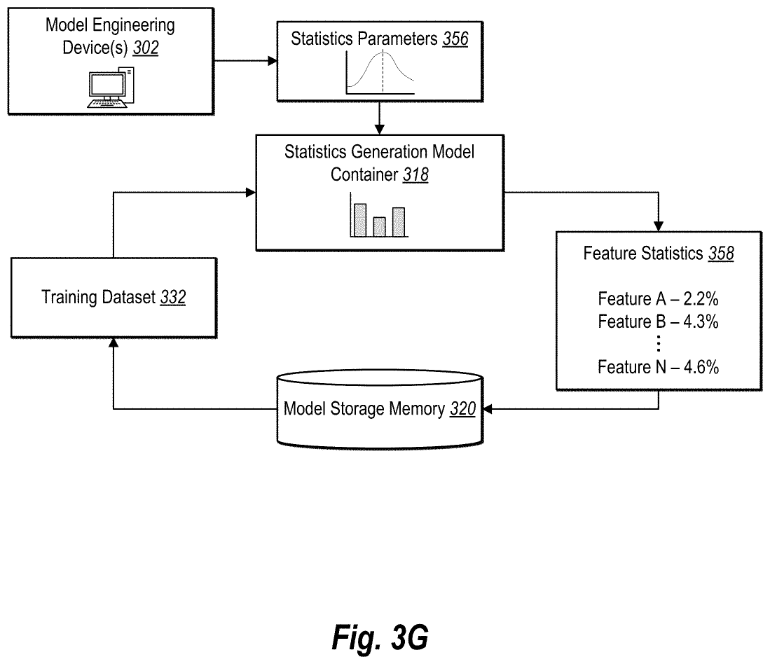

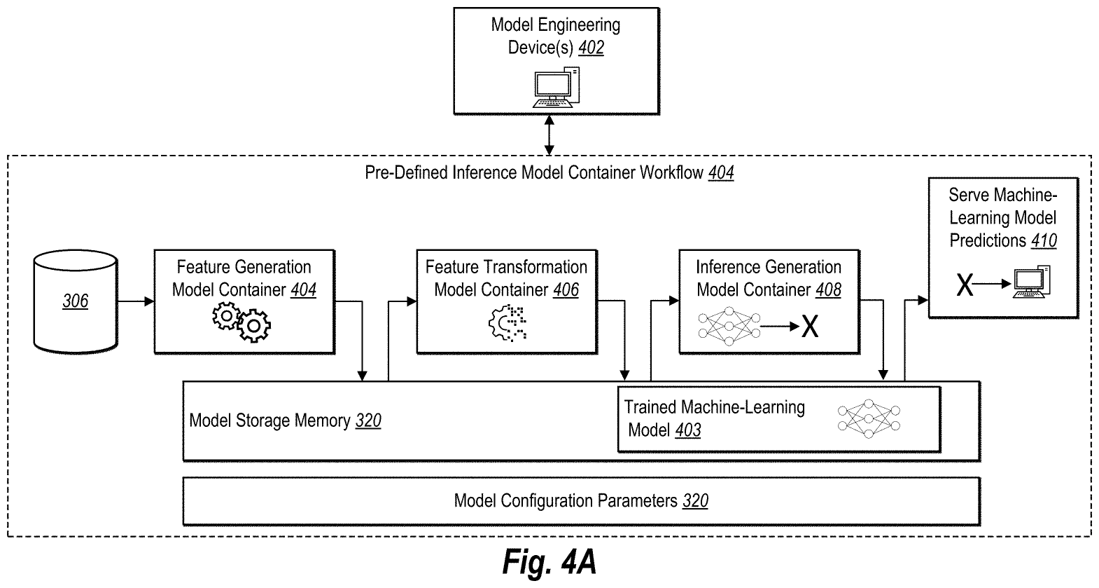

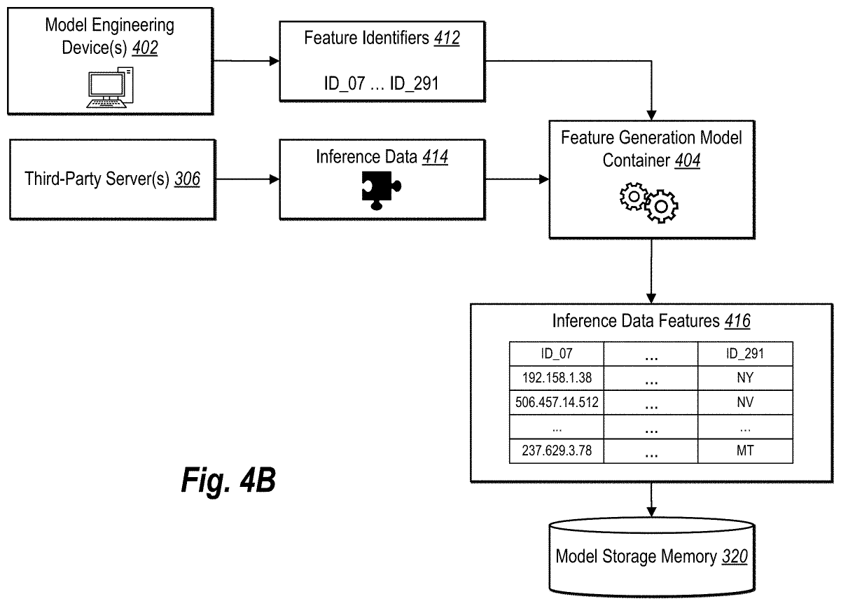

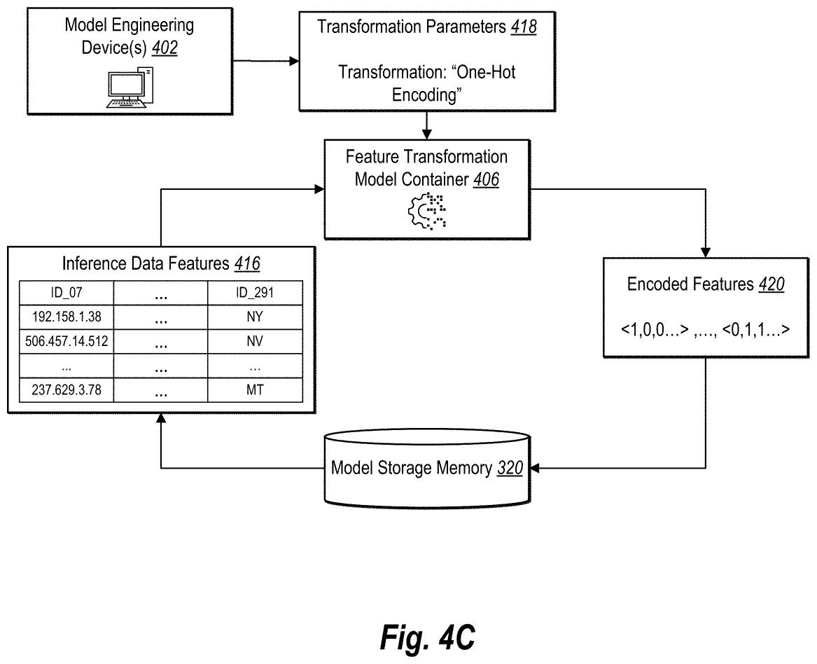

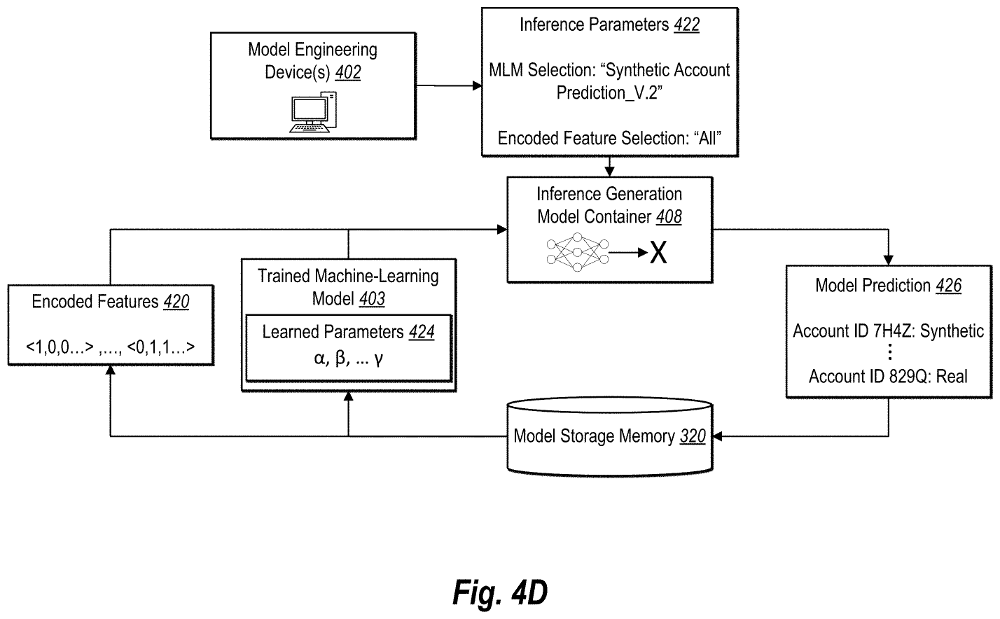

As illustrated by the foregoing discussion, the present disclosure utilizes a variety of terms to describe features and benefits of the machine-learning platform system. Additional detail is now provided regarding the meaning of these terms. For example, as used herein, the term “pre-defined model container” refers to a predetermined framework of computer-executable instructions. In particular embodiments, a pre-defined model container includes a standardized unit of template codebase with portions to be filled in with conforming user code. Examples of a pre-defined model container include a data generation model container, a data transformation model container, or a training-tuning model container (e.g., as described in more detail in relation to FIGS. 3A-3G and FIGS. 4A-4D). In certain implementations, a pre-defined model container includes a Docker container.

Relatedly, the term “pre-defined model container workflow” refers to a combination, arrangement, or sequence of pre-defined model containers. In particular embodiments, a pre-defined model container workflow includes pre-defined model containers that, in combination, perform a machine-learning model task. For example, a pre-defined model container workflow can include a pip package (e.g., a package management system written in Python) that (i) comprises tooling for training a machine-learning model, generating model inferences, or performing other model tasks, (ii) containerizes model code, and (iii) implements model agnostic code with entry points, serving stack, logging and monitoring, etc. One particular example of a pre-defined model container workflow includes a pre-defined model container workflow for training (as described below in relation to FIGS. 3A-3G). Another example workflow includes a pre-defined inference model container workflow (e.g., a pre-defined model container workflow for inference as described below in relation to FIGS. 4A-4D).

In addition, as used herein, the term “machine-learning model” refers to a model that can be tuned (e.g., trained) based on inputs to approximate unknown functions. In particular, the term machine-learning model can include a neural network that includes interconnected neurons arranged in layers that communicate and learn to approximate complex functions and generate outputs based on a plurality of inputs provided to the model. The term machine-learning model includes deep convolutional neural networks (“CNNs”), fully convolutional neural networks (“FCNs”), or recurrent neural networks (“RNNs”) such as long short-term memory neural networks (“LSTMs”). Additionally or alternatively, the term machine-learning model includes a random forest model, a series of gradient boosted decision trees (e.g., XGBoost algorithm), a multilayer perceptron, a linear regression, a support vector machine, a deep tabular learning architecture, a deep learning transformer (e.g., self-attention-based-tabular transformer), or a logistic regression. In other words, a machine-learning model is an algorithm that implements deep learning techniques or machine learning that utilizes a set of algorithms to attempt to model high-level abstractions in data.

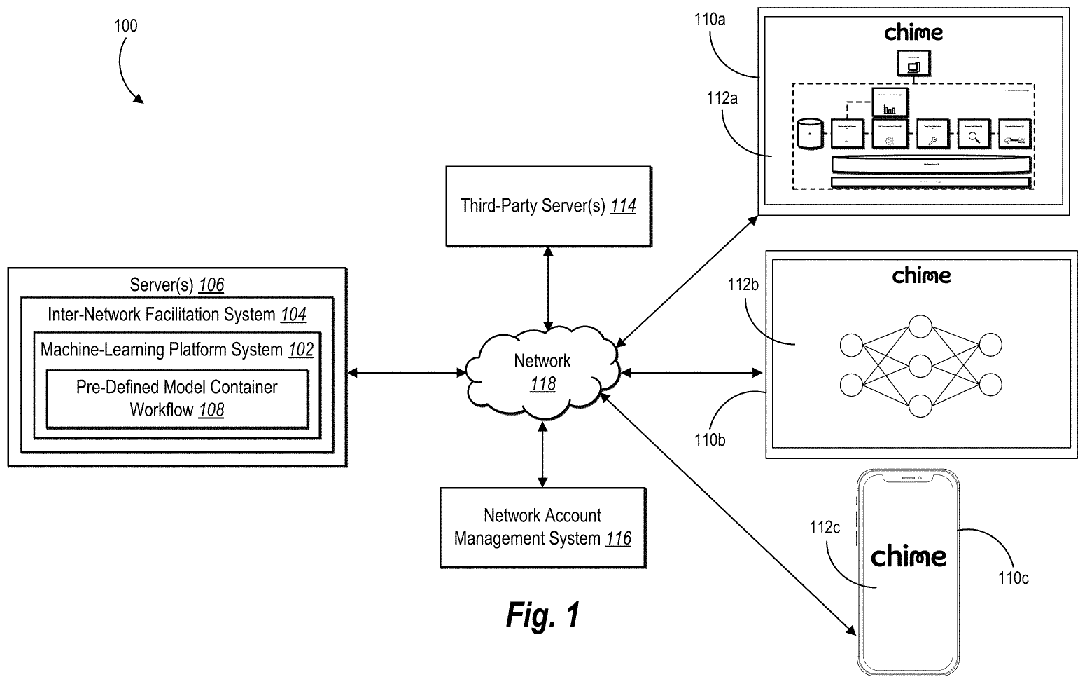

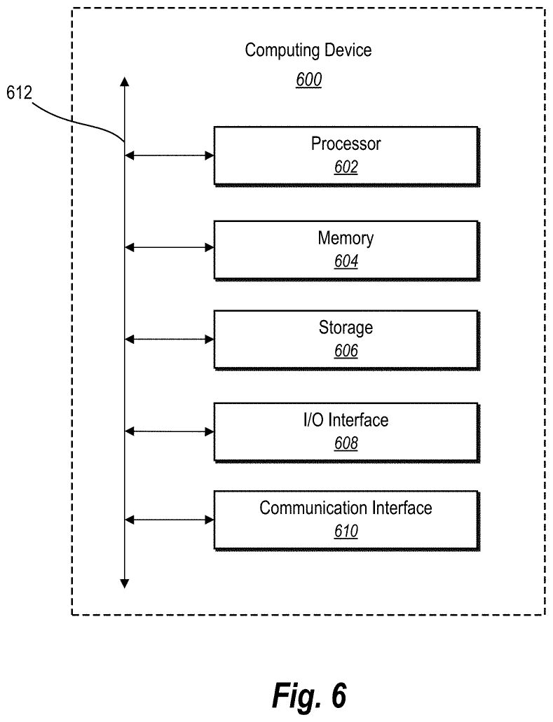

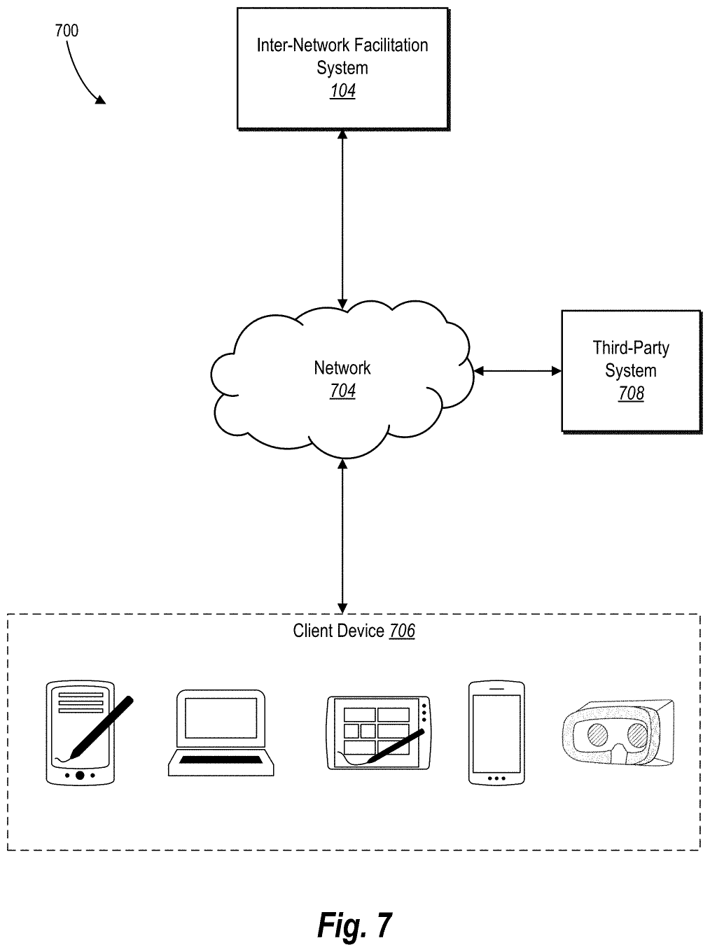

Additional detail regarding the machine-learning platform system will now be provided with reference to the figures. In particular, FIG. 1 illustrates a computing system environment for implementing a machine-learning platform system 102 in accordance with one or more embodiments. As shown in FIG. 1, the environment includes server(s) 106, a variety of client devices (e.g., workflow management device(s) 110a, model engineering device(s) 110b, and client device(s) 110c), third-party server(s) 114, and a network account management system 116. Each of the components of the environment 100 communicate (or are at least configured to communicate) via the network 118, and the network 118 may be any suitable network over which computing devices can communicate. Example networks are discussed in more detail below in relation to FIGS. 6-7.

As further illustrated in FIG. 1, the environment 100 includes the server(s) 106. In some embodiments, the server(s) 106 comprises a content server, a historical data (feature store) server, and/or a data collection server. Additionally or alternatively, the server(s) 106 comprise an application server, a communication server, a web-hosting server, a social networking server, a digital content management server, a machine-learning model development server, or a financial payment server.

Moreover, as shown in FIG. 1, the server(s) 106 implement an inter-network facilitation system 104. In one or more embodiments, the inter-network facilitation system 104 (or the machine-learning platform system 102) communicates with the client device(s) 110a-110(n) to identify or provide information relating to machine-learning models. More specifically, the inter-network facilitation system 104 (or the machine-learning platform system 102) can communicate with one or more of the client devices 110a-110c to indicate information relating to pre-defined model container workflows.

As additionally shown in FIG. 1, the machine-learning platform system 102 implements a pre-defined model container workflow 108. When executed, the pre-defined model container workflow 108 performs machine-learning model tasks. Specifically, upon execution, the pre-defined model container workflow 108 uses a combination of independent pre-defined model containers to perform machine-learning model tasks, such as training or batch inference.

Further, the environment 100 includes a variety of client devices, including the workflow management device(s) 110a, the model engineering device(s) 110b, and the client device(s) 110c. These client devices can include one of a variety of computing devices, including a smartphone, tablet, smart television, desktop computer, laptop computer, virtual reality device, augmented reality device, or other computing device as described in relation to FIGS. 6-7. Although FIG. 1 illustrates only a single instance of these client devices, the environment 100 can include many different client devices connected to each other via the network 118 (e.g., as denoted by the separating ellipses).

Further, in some embodiments, workflow management device(s) 110a generate pre-defined model containers for a machine learning pipeline. The machine-learning platform system 102 can provide user interfaces illustrating the pipeline and/or containers to the model engineering device(s) 110b and the model engineering device(s) can provide various parameters for training or implementing a machine learning model. The machine-learning platform system 102 can utilize the pre-defined model containers to train or implement a machine learning model utilizing the various parameters. During inference time, the machine-learning platform system 102 can interact with the client device(s) 110c to identify features and generate/provide predictions. For example, in implementing a fraud detection machine learning model, the machine-learning platform system 102 can train the fraud detection machine learning model (based on parameters from the model engineering device(s) 110b utilizing the pre-defined model containers), identify features of the client device 110c, and predict whether the client device 110c is fraudulently attempting to access or utilize a digital account corresponding to the inter-network facilitation system 104.

Moreover, as shown, the client devices include corresponding client applications 112a-112c. The client applications 112a-112c can each include a web application, a native application installed on the client devices 110a-110c (e.g., a mobile application, a desktop application, a plug-in application, etc.), or a cloud-based application where part of the functionality is performed by the server(s) 106. In some embodiments, the machine-learning platform system 102 causes the client applications 112a-112c to present or display information to a user associated with the client devices 110a-110c, including information relating to one or more different pre-defined model container workflows or machine learning model inferences.

Further shown in FIG. 1, the environment 100 includes the third-party server(s) 114. In one or more embodiments, the third-party server(s) 114 include one or more servers for data repositories, testing platforms, integration/delivery (CI/CD) platforms, etc. Accordingly, the third-party server(s) 114 can communicate with the client devices 110a-110c and/or the machine-learning platform system 102 to provide certain inputs for the pre-defined model container workflow 108.

In addition, the machine-learning platform system 102 can communicate with the network account management system 116 regarding one or more network transactions. For example, the machine-learning platform system 102 can communicate with the network account management system 116 to identify one or more of transaction data, network account data, device data corresponding to consumer client devices, etc.

In some embodiments, though not illustrated in FIG. 1, the environment 100 has a different arrangement of components and/or has a different number or set of components altogether. For example, in certain embodiments, the client devices 110a-110c communicate directly with the server(s) 106, bypassing the network 118.

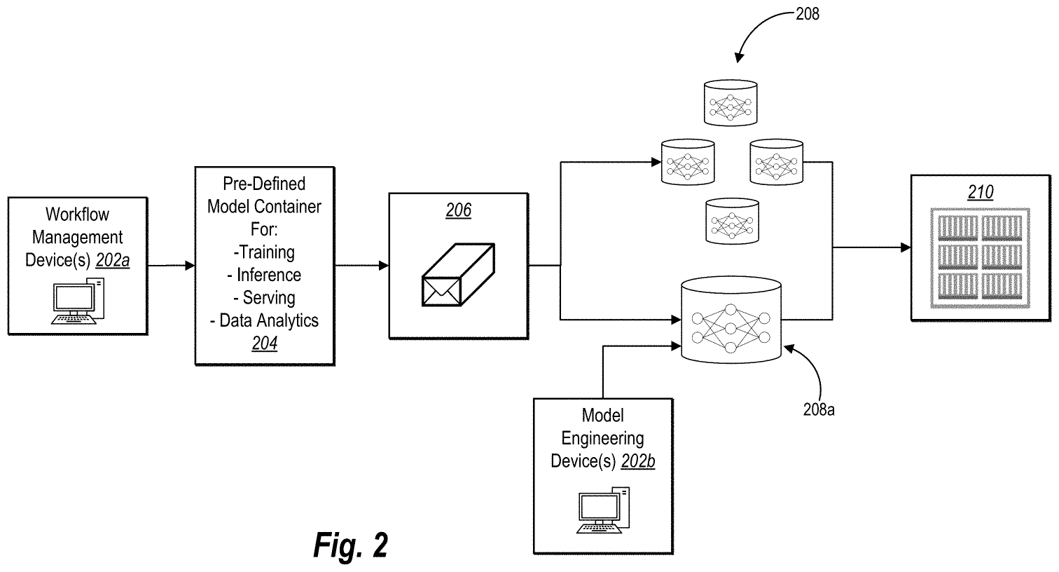

As mentioned above, the machine-learning platform system 102 can provide a flexible and efficient way of managing the life cycle of a machine-learning model—including development, training, testing, deployment, and maintenance of a machine-learning model. In accordance with one or more embodiments, FIG. 2 illustrates the machine-learning platform system 102 utilizing pre-defined model container workflows 204 that package software tooling and coding for performing model tasks in relation to one or more different machine-learning models.

In particular, workflow management device(s) 202a build out the pre-defined model container workflows 204. For example, the workflow management device(s) 202a generate computer-executable instructions to create pre-defined model containers with template codebases. In turn, the workflow management device(s) 202a can assemble these template codebases that are individually containerized into a particular workflow for performing one or more model tasks. Examples of such workflows include pre-defined model container workflows for performing training, inference generation, serving, data analytic generation, etc.

Additionally shown in FIG. 2, implementing client device(s) use the machine-learning platform system 102 to package or format the pre-defined model container workflows 204 into a software package 206. The software package 206 can include software tooling for executing the pre-defined model container workflows 204. In addition, the software package 206 can include one or more different types of packaging. For example, the software package 206 may include a Python pip package. In certain implementations, the software package 206 includes a docker image (or other base images) comprising one or more of the pre-defined model container workflows 204. In some embodiments, the software package 206 includes SemVer versioning.

The machine-learning platform system 102 integrates the software package 206 with a variety machine-learning models in one or more different ways. For example, the machine-learning platform system 102 integrates the software package 206 with a plurality of machine-learning models 208. In certain implementations, the machine-learning platform system 102 automatically executes the software package 206 to operate in conjunction with the plurality of machine-learning models 208. Alternatively, in certain implementations, the machine-learning platform system 102 implements the software package 206 with the plurality of machine-learning models 208 on a request-upgrade basis. For instance, the machine-learning platform system 102 may apply the software package 206 to a particular machine-learning model 208a of the plurality of machine-learning model repositories 208 in response to user input or an upgrade request from model engineering device(s) 202b (e.g., an example client device as described in FIG. 1 above).

As described in greater detail below, the model engineering device(s) 202b can provide a variety of parameters to the machine-learning platform system 102 that can be integrated into the pre-defined model containers to train or implement a machine learning model. The model engineering device(s) 202b can also modify these parameters (e.g., to change model architectures, training data, testing protocols, or statistical analyses). Thus, the machine-learning platform system 102 can flexibly accommodate a variety of machine learning models, training data sets, or other machine learning parameters while maintaining consistency and accuracy.

Furthermore, the workflow management device(s) 202a can also modify the workflow and/or individual pre-defined model containers within the workflow. Indeed, by creating or modifying pre-defined model containers the machine-learning platform system 102 can globally implement changes consistently and accurately across a myriad of different machine learning models. This can allow for efficient and flexible revisions and modifications while maintaining consistency and accuracy within a machine learning model process and across different projects.

After integration, the machine-learning platform system 102 registers a machine-learning model for storage in a model storage memory 210. The machine-learning platform system 102 can implement one or more different types of model storage memory. In certain implementations, the model storage memory 210 comprises a third-party server (e.g., an AMAZON® elastic container registry). In other implementations, the model storage memory 210 comprises local storage on one or more of the client device(s) 202a-202b. Still, in other embodiments, the model storage memory 210 comprises storage on one or more of the server(s) 106 described above in relation to FIG. 1.

From the model storage memory 210, the machine-learning platform system 102 can dynamically execute the software package 206 for implementing the pre-defined model container workflows 204. Some example methods of executing certain pre-defined model container workflows are described below in relation to FIGS. 3A-3G and FIGS. 4A-4D.

Although FIG. 2 and other example embodiments describe containers particular to training or implementing machine learning model, the disclosure is not limited to machine-learning model implementations. For example, the machine-learning platform system 102 can modify, omit, or add to the foregoing pre-defined model container workflows. Additionally, it will be appreciated that the machine-learning platform system can provide pre-defined model container workflows for myriad other applications—including applications beyond machine learning. For instance, in some embodiments, the machine-learning platform system implements a data analytics workflow with pre-defined analytics containers for transforming data. Similarly, the machine-learning platform system can integrate with a variety of different third-party software applications, data repositories, compute instances, software tooling or services, etc. It will also be appreciated that the content of each pre-defined model container is customizable. Indeed, certain pre-defined model containers can include one or more different frameworks for, as examples, organizing code, storing data, processing inputs, generating outputs, or calling variables.

As mentioned above, the machine-learning platform system 102 can implement pre-defined model container workflows for performing one or more model tasks. In accordance with one or more such embodiments, FIG. 3A illustrates the machine-learning platform system 102 implementing a pre-defined model container workflow 304 for training one or more machine-learning models.

As shown in FIG. 3A, the machine-learning platform system 102 provides inputs from model engineering device(s) 302 to the pre-defined model container workflow 304. The inputs can correspond to a single element or multiple elements of the pre-defined model container workflow 304. In particular embodiments, the inputs from the model engineering device(s) 302 vary depending on the element of the pre-defined model container workflow 304 receiving the inputs. Indeed, as will be explained below in relation to FIGS. 3B-3G, the machine-learning platform system 102 can provide one or more different user inputs from the model engineering device(s) 302 with respect to third-party server(s) 306, a data generation model container 308, a data transformation model container 310, a training-tuning model container 312, an evaluation model container 314, a registration model container 316, a statistics generation model container 318, a model storage memory 320, and/or model configuration parameters 322.

With inputs from the model engineering device(s) 302, the machine-learning platform system 102 can execute the code corresponding to one or more elements of the pre-defined model container workflow 304 to train a machine-learning model. For instance, as a brief overview, the data generation model container 308 uses data from the third-party server(s) 306 (e.g., a SNOWFLAKE® server, a GLUE® server, a JUPYTER® notebook server, etc.) to generate one or more datasets for training and/or evaluating a machine-learning model.

In addition, the data transformation model container 310 enables sharing of data transformations between training and inference/serving of a machine-learning model. In particular embodiments, the data transformation model container 310 shares data transformations in such a way that decreases or eliminates feature parity issues between computer code for training and inference (often resulting from duplicated coding errors). Moreover, by transforming or converting datasets, the data transformation model container 310 provides automated (or semi-automated) compatibility with certain compute instances requiring that the datasets for machine-learning training and/or evaluation correspond to a particular format and/or object storage location (e.g., an S3 path).

The training-tuning model container 312 performs the training tasks for training a machine-learning model. Additionally, the evaluation model container 314 performs model evaluation of a trained machine-learning model. In certain implementations, the evaluation model container 314 generates a machine-learning testing metric (e.g., for determining whether the machine-learning model is ready for implementation). Relatedly, the statistics generation model container 318 generates statistics for the training data.

The registration model container 316 registers the trained machine-learning model with the model storage memory 320 (e.g., a model store). In certain implementations, the registration model container 316 freezes pip packages, calls the model storage memory 320, and registers a docker image or artifact (e.g., with an AMAZON® elastic container registry, AMAZON® S3 bucket, etc.).

Further shown in FIG. 3A, the pre-defined model container workflow 304 comprises the model storage memory 320. The model storage memory 320 can include one or more different memory blocks or partitions associated with one or more different memory devices. In certain implementations, the model storage memory 320 can include one or more servers corresponding to the server(s) 106 or local storage on the model engineering device(s) 302. Additionally or alternatively, the model storage memory 320 can include one or more servers corresponding to the third-party server(s) 114 or the third-party server(s) 306.

In certain embodiments, the machine-learning platform system 102 utilizes the model storage memory 320 in one or more different ways. In certain implementations, the machine-learning platform system 102 utilizes the model storage memory 320 such that each pre-defined model container is independent of other pre-defined model containers. That is, in some embodiments, the pre-defined model container workflow 304 excludes direct state sharing between pre-defined model containers. Instead, the machine-learning platform system 102 utilizes an indirect state sharing approach that implements the model storage memory 320 as a system touchpoint between pre-defined model containers. For example, in addition to inputs from the model engineering device(s) 302, the machine-learning platform system 102 can provide one or more different inputs to a pre-defined model container from the model storage memory 320. In certain implementations, these inputs provided from the model storage memory 320 to a particular pre-defined model container correspond to the stored outputs from one or more other pre-defined model containers.

By utilizing this approach, the machine-learning platform system 102 also provides additional insight, flexibility, and accuracy relative to conventional systems. For example, the model engineering device(s) 302 can access intermediate data stored within the model storage memory 320 from any of the pre-defined model containers for any historical projects utilizing a machine-learning model workflow. To illustrate, the model engineering device(s) 302 can determine datasets accessed, transformed data, and machine learning model architecture, or learned machine learning model parameters (e.g., weights or nodes) for any particular training instance of a machine learning model throughout its history.

In addition to the model storage memory 320, the pre-defined model container workflow 304 further comprises the model configuration parameters 322. The model configuration parameters 322 can include files that configure model hyperparameters, network layout for distributed training, etc. For example, in certain implementations, the model configuration parameters 322 define which compute instances perform which pre-defined model containers of the pre-defined model container workflow 304.

Additionally or alternatively, the model configuration parameters 322 include security parameters (e.g., with respect to hardcoded credentials, credential logging, guardrails around what data sources are accessed and under what contexts, etc.). Further, such security parameters can include parameters for input sanitization, prevention of insecure direct object references, etc.

In at least some embodiments, the model configuration parameters 322 include parameters for metadata tracking, storage, and model implementation. For example, the model configuration parameters 322 include parameters for model names, model description, model owners, model training, training pairs (e.g., key-value pairs), timestamp run times, execution run identifiers, recording of model inputs/outputs, etc.

It will be appreciated that the pre-defined model container workflow 304 of FIG. 3A can include myriad different configurations and/or combinations of components. For example, in certain implementations, the machine-learning platform system 102 uses one or more different servers instead of the third-party server(s) 306 to retrieve digital information (e.g., the server(s) 106). As another example, the machine-learning platform system 102 uses one or more particular docker container structures to store the pre-defined model container workflow 304 on a containerized basis in a code directory (different than the model storage memory 320). For instance, the machine-learning platform system 102 can store the same or different pre-defined model containers for the pre-defined model container workflow 304 within the code directory according to an example structure shown below in Table 1.

TABLE 1

/opt/ml
|_processing
| |_output
| |_train
| |_validation
| |_test
|_input
| |_config
| | |_hyperparameters.json
| | |_resourceConfig.json
| |_raw
| |_data
| |_<channel_name>
| |_<input data>
|_model
| |_<model files>
|_code
| |_preprocessing.py
| |_train
| |_inference
|_output
|_failure

Further detail will now be provided regarding each pre-defined model container of the pre-defined model container workflow 304. Specifically, FIGS. 3B-3G illustrate the machine-learning platform system 102 implementing particular pre-defined model containers of the pre-defined model container workflow 304 in accordance with one or more embodiments. As will be appreciated from the following description, each pre-defined model container performs one or more model tasks related to training.

In FIG. 3B, the machine-learning platform system 102 implements a data generation model container 308 for generating a set of data 328 (e.g., for training and/or evaluating a machine-learning model). As used herein, the term “data generation model container” refers to a predetermined framework of computer-executable instructions for generating a dataset. In particular embodiments, a data generation model container includes a pre-defined model container formatted as a standardized unit of template codebase (e.g., a Docker container) with portions to be filled in with conforming user code that defines the dataset objects that will compose a dataset of interest.

To generate the set of data 328, the machine-learning platform system 102 provides a data identifier 324 from model engineering device(s) 302. As used herein, the term “data identifier” refers to an indicator of digital information (e.g., a title, path, file location, variable, class, or category of training data). In particular embodiments, a data identifier delineates, qualifies, or identifies a set of data. For example, for a machine learning model that analyzes IP addresses to determine fraudulent devices, the machine-learning platform can utilize an identifier that indicates a subset of internet protocol (IP) addresses that satisfy one or more conditions (e.g., an IP distance condition).

The data generation model container 308 can receive the data identifier 324 in one or more different ways. In certain embodiments, executing the code of the data generation model container 308 causes the machine-learning platform system 102 to instantiate a graphical user interface on the model engineering device(s) 302 requesting the data identifier 324. For instance, the graphical user interface may include an interactive prompt, a screen alert, or a digital notification requesting user input that corresponds to the data identifier 324. In other embodiments, the data generation model container 308 comprises place-holder coding, pseudocode, or commented-out portions indicating a request for a user to enter in the data identifier 324.

Upon execution, the data generation model container 308 uses the data identifier 324 to generate digital queries 326 (e.g., information retrieval requests). The data generation model container 308 can do so in one or more different ways. For example, the data generation model container 308 can transform or pass the data identifier 324 into a call function (e.g., “prepare_data( )”) that calls or queries the data identifier 324 at the third-party server(s) 306. As another example, the data generation model container 308 formulates the digital queries 326 by using the data identifier 324 as inputs for a query generation function. In turn, the data generation model container 308 transmits or executes the digital queries 326 with respect to the third-party server(s) 306.

Based on executing the digital queries 326, the data generation model container 308 retrieves the set of data 328 from the third-party server(s) 306. Subsequently, the data generation model container 308 provides the set of data 328 to the model storage memory 320. As will be appreciated from the below description, the machine-learning platform system 102 can then use the set of data 328 at the model storage memory 320 in relation to a variety of different pre-defined model containers and/or pre-defined model container workflows (including non-training ones).

In FIG. 3C, the machine-learning platform system 102 implements a data transformation model container 310 to generate a training dataset 332 for training a machine-learning model. As used herein, the term “data transformation model container” refers to a predetermined framework of computer-executable instructions for generating a training dataset. In particular embodiments, a data transformation model container includes a pre-defined model container formatted as a standardized unit of template codebase (e.g., a Docker container) with portions to be filled in with conforming user code that defines a predetermined format for transforming or converting data into a training dataset. Upon execution of such code, a data transformation model container formats data into a training dataset.

As shown in FIG. 3C, execution of the data transformation model container 310 generates the model configuration parameters 322 by using transformation parameters 330 to transform the set of data 328 retrieved from the model storage memory 320. As used herein, the term “transformation parameters” refers to parameters defining a format or data mapping for a set of data. In particular embodiments, transformation parameters map variables, values, columns, rows, vector elements, etc. to a predetermined format. For example, transformation parameters include parameters for encoding or transmitting data (e.g., for single hypertext transmission protocol input requests or split-type input requests with formats like Line, JSONLine, RecordIO, TFRecord, comma-separated value, etc.). Additionally or alternatively, it will be appreciated that transformation parameters can include various parameters for code hygiene (e.g., test coverage, security scans, linting, etc.).

To obtain the transformation parameters 330, the machine-learning platform system 102 can provide the transformation parameters 330 to the data transformation model container 310 in a similar fashion as described above in relation to the data identifier 324 of FIG. 3B. Indeed, the data transformation model container 310 can cause the machine-learning platform system 102 to instantiate a graphical user interface on the model engineering device(s) 302 requesting the transformation parameters 330 from the model engineering device(s) 302. Alternatively, the data transformation model container 310 comprises place-holder code, pseudocode, or commented-out portions indicating a request for the model engineering device(s) 302 to provide the transformation parameters 330.

Based on the transformation parameters 330, the data transformation model container 310 can generate the training dataset 332 for storing in the model storage memory 320 (e.g., for each training run). For example, the data transformation model container 310 uses the transformation parameters 330 to reformat the set of data 328. In one or more embodiments, the data transformation model container 310 reformats the set of data 328 such that the training dataset 332 is compatible with one or more compute instances. Additionally or alternatively, generating the training dataset 332 comprises generating a python file (e.g., a “model transformation.py” file and/or a pip package) for sharing transformations with one or more other pre-defined model containers. In at least some embodiments, generating the training dataset 332 comprises selecting a subset of the set of data 328 (e.g., leaving a different subset of the set of data 328 for testing).

In other embodiments not illustrated, generating the training dataset 332 comprises implementing a separate pre-defined model container workflow for transforming the set of data 328. For instance, the machine-learning platform system 102 may implement a pre-defined model container workflow comprising multiple pre-defined model containers that perform different and/or step-wise transformations.

In FIG. 3D, the machine-learning platform system 102 uses the training-tuning model container 312 to train a machine-learning model 336. As used herein, the term “training-tuning model container” refers to a predetermined framework of computer-executable instructions for performing machine-learning training runs on a compute instance. In particular embodiments, a training-tuning model container includes a pre-defined model container formatted as a standardized unit of template codebase (e.g., a Docker container) with portions to be filled in with conforming user code that defines a training process, training parameters, etc. for training a machine-learning model.

As shown in FIG. 3D, machine-learning platform system 102 provides hyperparameters 334 to the training-tuning model container 312 from the model engineering device(s) 302. As used herein, the term “hyperparameters” refers to training parameters that control training a machine-learning model. Examples of hyperparameters include a learning rate, mini-batch size, maximum iteration count, epochs, machine learning architecture (e.g., number or type of layers, nodes, trees, etc.), number of k nearest neighbors, etc.

As similarly described above, the machine-learning platform system 102 can provide the hyperparameters 334 to the training-tuning model container 312 in a variety of ways. For example, the machine-learning platform system 102 can obtain or identify the hyperparameters 334 via interactive graphical user interfaces or via user input directly inserting the hyperparameters 334 at predetermined areas (e.g., placeholder code portions).

With the hyperparameters 334, the training-tuning model container 312 can cause the machine-learning model 336 to generate training predictions 338 for the training dataset 332. In one or more embodiments, the machine-learning model 336 generates the training predictions 338 based on the network or structure of the machine-learning model 336. For example, certain types of the machine-learning model 336 generate binary classifications (e.g., 1 or 0, fake or real, etc.), probability values, score predictions, categorical predictions, recommendations, and the like.

At an act 340, the training-tuning model container 312 compares the training predictions 338 and ground truth data. The ground truth data can include predetermined, observed, measured, annotated, real, true, or verified data.

In one or more embodiments, the act 340 comprises the training-tuning model container 312 comparing the 338 and the ground truth data utilizing a loss function. In particular embodiments, the loss function comprises a regression loss function (e.g., a mean square error function, a quadratic loss function, an L2 loss function, a mean absolute error/L1 loss function, mean bias error). Additionally or alternatively, the loss function can include a classification-type loss function (e.g., a hinge loss/multi-class SVM loss function, cross entropy loss/negative log likelihood function). In particular embodiments, the loss function comprises a k-fold cross-validation function.

At an act 342, the training-tuning model container 312 modifies one or more learned parameters of the machine-learning model 336. For example, the loss function can return quantifiable data (e.g., losses) regarding the difference between a given training prediction from the training predictions 338 and a corresponding ground truth. Based on these losses, the training-tuning model container 312 adjusts various parameters to improve the quality/accuracy of the training predictions 338 in subsequent training iterations—by narrowing the difference between the training predictions 338 and ground truth data in subsequent training iterations. In addition, the one or more modified parameters (or other model artifacts) can be stored on the model storage memory 320 (albeit separate from the inference pipeline).

In alternative embodiments, the training-tuning model container 312 comprises a different structure than illustrated in FIG. 3D. For example, in one or more embodiments, the training-tuning model container 312 comprises a structure for unsupervised training of the machine-learning model 336. To illustrate, in certain implementations, the machine-learning model 336 comprises a generative adversarial network that uses a discriminator model as opposed to ground truth data for learning parameters.

Further, it will be appreciated that certain embodiments of the training-tuning model container 312 include code for performing various other acts not explicitly illustrated in FIG. 3D. For example, in one or more embodiments, the training-tuning model container 312 includes code for writing debug output (e.g., errors to an error file or logging errors in a rollbar). As further examples, the training-tuning model container 312 includes code for writing a model artifact, defining configuration paths to training data, etc.

In FIG. 3E, the evaluation model container 314 uses a test dataset 344 to evaluate a trained machine-learning model (e.g., the machine-learning model 336). As used herein, the term “evaluation model container” refers to a predetermined framework of computer-executable instructions for testing a machine-learning model. In particular embodiments, an evaluation model container includes a pre-defined model container formatted as a standardized unit of template codebase (e.g., a Docker container) with portions to be filled in with conforming user code that defines testing procedures, testing parameters, etc. for generating a machine-learning testing metric.

To generate the test dataset 344, the machine-learning platform system 102 utilizes a same or similar approach discussed above in relation to FIG. 3C for generating the training dataset 332. For example, the machine-learning platform system 102 provides the transformation parameters 330 to the data generation model container 308 from the model engineering device(s) 302. Using the transformation parameters 330, the data generation model container 308 then transforms the set of data 328 into the test dataset 344. For example, the data generation model container 308 reformats, encodes, filters, truncates, or otherwise modifies the set of data 328. In certain implementations, the data generation model container 308 generates the test dataset 344 by selecting a different subset of the set of data 328 than used for the training dataset 332 (e.g., to test the machine-learning model on unseen data).

Upon storing the test dataset 344 at the model storage memory 320, the evaluation model container 314 can call or retrieve the test dataset 344 for testing a machine-learning model. To do so, the machine-learning platform system 102 provides testing parameters 346 to the evaluation model container 314 from the model engineering device(s) 302 (e.g., via interactive graphical user interfaces or via user input directly inserting the testing parameters 346). As used herein, the term “testing parameters” refers to parameters for controlling testing of a machine-learning model. Examples of testing parameters include testing iterations, testing metrics (e.g., values to be measured or evaluated for accuracy), thresholds or conditions relating to a machine-learning testing metric, etc.

Using the testing parameters 346, the evaluation model container 314 generates a machine-learning testing metric 348 for the test dataset 344. As used herein, the term “machine-learning testing metric” refers to one or more indicators, values, probabilities, etc. that indicate a testing result for a machine-learning model. Examples of a machine-learning testing metric include area under curve-receiver operating characteristic (AUC-ROC) values, precision scores, recall scores, F-scores, etc.

To generate the machine-learning testing metric 348, the evaluation model container 314 includes code for executing one or more algorithms that determine the machine-learning testing metric 348 based on a machine-learning model implementing the test dataset 344. For example, the evaluation model container 314 includes algorithms for determining and visualizing (e.g., via graphical charts) AUC-ROC values, precision-recall curves, and the like.

For example, the evaluation model container 314 can apply a trained machine-learning model to testing data and generate a prediction from the testing data. The evaluation model container 314 can then compare the prediction to a ground truth metric (e.g., a known value corresponding to the prediction). Based on the comparison, the evaluation model container 314 can generate a machine-learning testing metric 348. Subsequently, the evaluation model container 314 passes the machine-learning testing metric 348 to the model storage memory 320.

Although not shown, it will be appreciated that the evaluation model container 314 can also surface the machine-learning testing metric 348 at the model engineering device(s) 302. For example, the evaluation model container 314 may provide the machine-learning testing metric 348 and/or any corresponding heuristics for determining whether to implement a trained machine-learning model. For example, the evaluation model container 314 surfaces the machine-learning testing metric 348 at the model engineering device(s) 302 together with a visual indication (e.g., a color notification, a digital message, an icon, etc.) when the machine-learning testing metric 348 satisfies (and/or fails to satisfy) a threshold machine-learning testing metric threshold.

In FIG. 3F, the machine-learning platform system 102 implementing the registration model container 316. As used herein, the term “registration model container” refers to a predetermined framework of computer-executable instructions for registering a trained machine-learning model with one or more memory devices or software platforms. In particular embodiments, a registration model container includes a pre-defined model container formatted as a standardized unit of template codebase (e.g., a Docker container) with portions to be filled in with conforming user code that, when executed, registers a machine-learning model for deploying into production or CI/CD platforms.

As shown in FIG. 3F, the machine-learning platform system 102 provides registration parameters 352 to the registration model container 316 from the model engineering device(s) 302. As used herein, the term “registration parameters” refers to parameters for controlling how a server (e.g., a third-party compute instance) or other computing device stores and manages a machine-learning model. Examples of registration parameters include parameters for cataloging machine-learning models, managing model versions, associating metadata with machine-learning models, managing approval statuses of a machine-learning model, deploying models to production, and automating deployment to CI/CD platforms.

As similarly described above, the machine-learning platform system 102 can provide the registration parameters 352 to the registration model container 316 in a variety of ways. For example, the machine-learning platform system 102 can provide the registration parameters 352 via interactive graphical user interfaces or via user input directly inserting the registration parameters 352 at predetermined areas (e.g., placeholder code portions).

With the registration parameters 352, the registration model container 316 can register a trained machine-learning model 350. The registration model container 316 performs registration in one or more different ways. For example, the registration model container 316 generates a registered trained machine-learning model 354 for storing in the model storage memory 320 by assigning a memory file path, tagging metadata, and/or approving the trained machine-learning model 350 for production. As another example, the registration model container 316 generates the registered trained machine-learning model 354 by deploying and refining the trained machine-learning model 350 via one or more CI/CD platforms. Still further, another example includes the registration model container 316 generating the registered trained machine-learning model 354 by freezing (e.g., saving and disabling edits) to the trained machine-learning model 350. In yet another example, the registration model container 316 transmits the registration parameters 352 to a model store (e.g., via a model store application programming interface) for registering the trained machine-learning model 350 and providing metadata.

In FIG. 3G, the machine-learning platform system 102 implements a statistics generation model container 318. As used herein, the term “statistics generation model container” refers to a predetermined framework of computer-executable instructions for generating statistical data. In particular embodiments, a statistics generation model container includes a pre-defined model container formatted as a standardized unit of template codebase (e.g., a Docker container) with portions to be filled in with conforming user code that defines what types of statistics to determine and the statistical algorithms for determining such statistics.

As shown in FIG. 3G, the machine-learning platform system 102 provides statistics parameters 356 to the statistics generation model container 318 from the model engineering device(s) 302. As used herein, the term “statistics parameters” refers to thresholds, values, or parameters for performing one or more statistical analyses. Examples of statistics parameters include a number of clusters, data size, population, proportion, degree of fit, correlation, slope, distribution representation, etc. Additionally or alternatively, statistics parameters include algorithm identifiers and/or corresponding inputs (e.g., “avg(ip_distance)”) for indicating a selection of a desired statistical analysis.

In ways described above, the machine-learning platform system 102 can provide the statistics parameters 356 to the statistics generation model container 318 (e.g., via graphical user interfaces or via direct code insertion). Subsequently, the statistics generation model container 318 generates feature statistics 358 for the training dataset 332 according to the statistics parameters 356.

As used herein, the term “feature statistics” refers to statistical results from performing one or more statistical analyses on a dataset. For example, feature statistics include p-values, t-values, mean, median, mode, standard deviation, variance, minimums, maximums, fit, count, etc. It will be appreciated that feature statistics can be represented in myriad ways—including one or more of numerical values, graphical visualizations, or text-based summaries.

To generate the feature statistics 358, the machine-learning platform system 102 executes one or more algorithms of the statistics generation model container 318 to statistically analyze the training dataset 332 according to the statistics parameters 356. For example, the statistics generation model container 318 returns the feature statistics 358 comprising feature importance values according to the statistics parameters 356 indicating “Shapley values” as the desired statistical analysis. In this manner, the feature statistics 358 can indicate individual feature contributions to a training prediction of a machine-learning model.

In turn, the statistics generation model container 318 provides the feature statistics 358 to the model storage memory 320. Additionally or alternatively, in some embodiments, the statistics generation model container 318 provides the feature statistics 358 for display on the model engineering device(s) 302 via a graphical user interface.

As mentioned above, the machine-learning platform system 102 can implement pre-defined model container workflows for performing different model tasks. In accordance with one or more such embodiments, FIG. 4A illustrates the machine-learning platform system 102 implementing a pre-defined inference model container workflow 400 for generating a prediction from a trained machine-learning model 403.

As shown in FIG. 4A, the machine-learning platform system 102 provides inputs from model engineering device(s) 402 to the pre-defined inference model container workflow 400. In some embodiments, the model engineering device(s) 402 are the same as or similar to the model engineering device(s) 302 described above in relation to training a machine-learning model. In other embodiments, however, the model engineering device(s) 402 are different client device(s).

In one or more embodiments, the inputs correspond to a single element or multiple elements of the pre-defined inference model container workflow 400. In particular embodiments, the inputs from the model engineering device(s) 402 vary depending on the element of the pre-defined inference model container workflow 400 receiving the inputs. Indeed, as will be explained below in relation to FIGS. 4B-4D, the machine-learning platform system 102 can provide one or more different user inputs from the model engineering device(s) 402 with respect to the third-party server(s) 306, a feature generation model container 404, a feature transformation model container 406, an inference generation model container 408, the model storage memory 320, and/or the model configuration parameters 322.

Moreover, the machine-learning platform system 102 can provide inputs from the model engineering device(s) 402 to pre-defined model containers of the pre-defined inference model container workflow 400 in a variety of different ways. For example, as described above, the machine-learning platform system 102 can provide various types of parameters via interactive graphical user interfaces or via user input directly inserting the various parameters at predetermined areas (e.g., placeholder code portions within a pre-defined model container).

Additionally shown in FIG. 4A, the pre-defined inference model container workflow 400 includes access to the model storage memory 320 and the model configuration parameters 322. Indeed, one or more of the feature generation model container 404, the feature transformation model container 406, and/or the inference generation model container 408 can access the model storage memory 320 or the model configuration parameters 322 to perform a model task (e.g., as described below in relation to FIGS. 4B-4D.

The model storage memory 320 is described above in relation to at least FIG. 3A. However, as shown in FIG. 4A, the model storage memory 320 comprises the trained machine-learning model 403. Without limitation, the trained machine-learning model 403 can correspond to any trained machine-learning model—including a machine-learning model trained via the pre-defined model container workflow 304 described above in relation to FIGS. 3A-3G.

The model configuration parameters 322 are also described above in relation to at least FIG. 3A. However, some additional detail with respect to the pre-defined inference model container workflow 400 is now provided. In one or more embodiments, the model configuration parameters 322 include one or more parameters for executing certain pre-defined inference model containers on certain compute instances. For example, in certain implementations, the model configuration parameters 322 includes parameters for executing the feature generation model container 404 and the feature transformation model container 406 on one or more compute instances corresponding to AMAZON SAGEMAKER® Processing, AWS® Glue, or AMAZON SAGEMAKER® Data Wrangler. Similarly, in certain implementations, the model configuration parameters 322 includes parameters for executing the inference generation model container 408 on one or more compute instances corresponding to AMAZON SAGEMAKER® Batch Transform. In like manner, the model configuration parameters 322 can enforce representational state transfer (REST) compliance when executing the pre-defined inference model container workflow 400.

Further, in some embodiments, the model configuration parameters 322 comprise one or more parameters for executing different variations or inference modes of the pre-defined inference model container workflow 400. For example, the model configuration parameters 322 comprise one or more parameters for executing the pre-defined inference model container workflow 400 in real-time (or near real-time) on a rolling basis. As another example, the model configuration parameters 322 comprise one or more parameters for executing the pre-defined inference model container workflow 400 in batch mode. In certain implementations, the computer-executable instructions are different for implementing the pre-defined inference model container workflow 400 in a batch inference mode versus real-time inference mode. Accordingly, in some embodiments, the model configuration parameters 322 comprises one or more model directory paths for circumventing divergent code and/or executing the correct code for the desired inference mode.

In one or more embodiments, the model configuration parameters 322 comprise one or more defined variables utilized by the pre-defined model containers of the pre-defined inference model container workflow 400. For example, Table 2 below provides some example variables in accordance with one or more embodiments.

TABLE 2
*SAGEMAKER_BATCH: Always set to true when the container runs in
Batch Transform. Serves as a way to distinguish run commands for real
time inference versus batch inference.
*SAGEMAKER_MAX_PAYLOAD_IN_MB: is set to the largest size
payload that is sent to the container via HTTP
*SAGEMAKER_BATCH_STRATEGY: is set to SINGLE_RECORD
when the container is sent a single record per call to invocations and
MULTI_RECORD when the container gets as many records as will fit in
the payload
*SAGEMAKER_MAX_CONCURRENT_TRANSFORMS: is set to the
maximum number of invocations requests that can be opened
simultaneously

Additionally, in one or more embodiments, the model configuration parameters 322 define one or more inference-related endpoints as may be desired. For example, the model configuration parameters 322 may define ping endpoints, invocation endpoints, etc. for surfacing one or more predictions from the trained machine-learning model 403.

The following is a brief overview of the pre-defined inference model container workflow 400. The machine-learning platform system 102 can execute the pre-defined inference model container workflow 400 based on data from the model engineering device(s) 402, the model storage memory 320, and/or the model configuration parameters 322 to generate a prediction from the trained machine-learning model 403.

To illustrate, the feature generation model container 404 can retrieve or request data from the third-party server(s) 306. As described above, the third-party server(s) 306 can correspond to data lakes, repositories, notebook environments, etc. For example, the feature generation model container 404 can extract disputed transactions and/or corresponding application events in the last seven days (e.g., where the trained machine-learning model 403 corresponds to a dispute transaction model). As another example, the feature generation model container 404 can extract network account identifiers that transacted with a debit card in the last month but are not associated with a credit card (e.g., where the trained machine-learning model 403 corresponds to a credit builder model). It will be appreciated, however, that the feature generation model container 404 can retrieve this or other information from additional or alternative sources (e.g., the server(s) 106, the network account management system 116).

The feature transformation model container 406 utilizes data transformations to prepare data for inference generation. In one or more embodiments, the feature transformation model container 406 uses the same or similar data transformations as used for training the trained machine-learning model 403. By sharing data transformations from training, the feature transformation model container 406 can decrease or eliminate feature parity issues between computer code for training and inference.

The inference generation model container 408 generates one or more predictions from the trained machine-learning model 403 based on the transformed data. Myriad different types of predictions are within the scope of this disclosure. For example, the inference generation model container 408 may utilize the trained machine-learning model 403 to predict synthetic accounts, disputed transactions with a high likelihood of merchant chargeback, network accounts likely to sign up for a CHIME® Credit Builder Card, etc.

At an act 410, the machine-learning platform system 102 serves the machine-learning model predictions. For example, the machine-learning platform system 102 transmits the machine-learning model predictions from the model storage memory 320 to the model engineering device(s) 402, to the third-party server(s) 306 (e.g., SNOWFLAKE® servers, AMAZON® Simple Queue Service, Unit21 servers, etc.). In one or more embodiments, the act 410 comprises transmitting the machine-learning model predictions on a rolling basis as the inference generation model container 408 makes the predictions available at the model storage memory 320. In other embodiments, the act 410 comprises transmitting the machine-learning model predictions on a batch basis, on a per-request basis, etc.

In one or more embodiments, portions of the pre-defined inference model container workflow 400 as just described may be captured by the following example pseudocode of Table 3.

TABLE 3

#Define variables indicating whether inference is batch or real-time
#Load model artifact and prepare for inference
#Load model
#Implement predict method
#Implement predict batch method

Additionally, it will be appreciated that the pre-defined inference model container workflow 400 can include alternative embodiments (e.g., alternative structures and/or components) that are within the scope of this disclosure. For example, the machine-learning platform system 102 can implement one or more additional or alternative pre-defined model containers in the pre-defined inference model container workflow 400 than those illustrated in FIG. 4A. For example, the machine-learning platform system 102 may utilize different pre-defined model containers for real-time inference compared to batch inference. In addition to different containers, the machine-learning platform system 102 may also utilize a hosting inference service for real-time inference. For example, the machine-learning platform system 102 may implement the pre-defined inference model container workflow 400 with deployment to an HTTP endpoint for real-time inference. The trained machine-learning model 403 then makes real-time predictions in response to inference requests. The inference generation model container 408 (or another container) comprises a serving stack to process such inference requests.

As another example, the machine-learning platform system 102 can utilize pre-defined model containers that separate out or consolidate model tasks. For example, the machine-learning platform system 102 may implement separate pre-defined model containers that separately perform model tasks currently performed by a single pre-defined model container. An example of this task separation includes separating out the model tasks of identifying feature candidates and fetching features as performed by the feature generation model container 404. By contrast, in certain implementations, the machine-learning platform system 102 combines pre-defined model containers (e.g., the feature transformation model container 406 and the inference generation model container 408) to perform multiple model tasks within an individual container.

In yet another alternative embodiment, the machine-learning platform system 102 can optimize pre-defined model containers for the pre-defined inference model container workflow 400 by selectively downloading inference requirements and/or recreating separate pre-defined model containers.

Additionally, as another alternative embodiment, the machine-learning platform system 102 may execute the pre-defined inference model container workflow 400 by leveraging code stored on a single repository (e.g., the model storage memory 320) or multiple different repositories. For example, the machine-learning platform system 102 might leverage packages stored on AWS® Glue, AWS® Transform, MapReduce frameworks, etc. to perform different model tasks. These model tasks may include fetching historical data (e.g., feature store data), applying transformations, and so on as described above.

Further detail will now be provided regarding each pre-defined model container of the pre-defined inference model container workflow 400. Specifically, FIGS. 4B-4D illustrate the machine-learning platform system 102 implementing particular pre-defined model containers of the pre-defined inference model container workflow 400 in accordance with one or more embodiments. As will be appreciated from the following description, each pre-defined model container performs one or more model tasks related to generating a prediction from a machine-learning model.

In FIG. 4B, the machine-learning platform system 102 implements the feature generation model container 404. As used herein, the term “feature generation model container” refers to a predetermined framework of computer-executable instructions for generating a feature dataset. In particular embodiments, a feature generation model container includes a pre-defined model container formatted as a standardized unit of template codebase (e.g., a Docker container) with portions to be filled in with conforming user code that defines the dataset objects, attributes, or values that will compose a dataset for machine-learning model use.

As shown, the feature generation model container 404 uses feature identifiers 412 to select data features from inference data 414 (e.g., raw, measured, tracked, and/or historical data from the third-party server(s) 306). The feature identifiers 412 can refer to an indicator of digital information for implementing a machine-learning model (e.g., a title, path, file location, variable, class, or category of inference data). In particular embodiments, the feature identifiers 412 delineate, qualify, or identify a set of data. For example, in a machine learning model that analyzes IP addresses to make a prediction, the feature generation model container 404 can use the feature identifiers 412 to discriminate or selectively choose a subset of IP addresses from the inference data 414 that satisfy one or more conditions (e.g., an IP distance condition).

Based on selectively identifying datapoints from the inference data 414, the feature generation model container 404 generates inference data features 416. For example, the feature generation model container 404 generates a table, vector, or other data structure comprising the portions of the inference data 414 that correspond to the feature identifiers 412. Subsequently, the feature generation model container 404 provides the inference data features 416 to the model storage memory 320.

In alternative embodiments, the feature generation model container 404 retrieves or requests the inference data 414 from additional or alternative sources that differ from the third-party server(s) 306. For example, in one or more embodiments, the feature generation model container 404 uses the server(s) 106 and/or the network account management system 116 to source the inference data 414.

In FIG. 4C, the machine-learning platform system 102 implements the feature transformation model container 406. As used herein, the term “feature transformation model container” refers to a predetermined framework of computer-executable instructions for transforming data into data compatible with a machine-learning model. In particular embodiments, a feature transformation model container includes a pre-defined model container formatted as a standardized unit of template codebase (e.g., a Docker container) with portions to be filled in with conforming user code that defines a predetermined format for transforming inference data into encoded features.

As shown in FIG. 4C, the feature transformation model container 406 generates encoded features 420 (e.g., a machine-learning model readable version of the inference data features 416). To generate the encoded features 420, the feature transformation model container 406 uses transformation parameters 418 from the model engineering device(s) 402. The transformation parameters 418 may be the same as or similar to the transformation parameters 330 described above in relation to FIG. 3C. For example, the transformation parameters 418 indicate a desired (or required) type of data format for the inference data features 416 (e.g., for machine-learning model compatibility).

Accordingly, the feature transformation model container 406 generates the encoded features 420 by using the transformation parameters 418 to map or transform the inference data features 416 to a particular type of vector (e.g., a one-hot encoding), hash sequence, or byte sequence. As another example, the feature transformation model container 406 generates the encoded features 420 by using the transformation parameters 418 to perform mean normalization or other suitable operations. Subsequently, the feature generation model container 404 provides the encoded features 420 to the model storage memory 320.

In FIG. 4D, the machine-learning platform system 102 implements the inference generation model container 408. As used herein, the term “inference generation model container” refers to a predetermined framework of computer-executable instructions generating a machine-learning model prediction. In particular embodiments, an inference generation model container includes a pre-defined model container formatted as a standardized unit of template codebase (e.g., a Docker container) with portions to be filled in with conforming user code that defines an inference process, inference parameters, etc. for generating a prediction from a machine-learning model.

As shown in FIG. 4D, the inference generation model container 408 uses inference parameters 422 to generate a model prediction 426. The inference parameters 422 can include one or more parameters for controlling how the model prediction 426 is generated. In particular embodiments, the inference parameters 422 include or more of a machine-learning model selection, an encoded feature selection, a model output type, etc.

Based on the inference parameters 422, the inference generation model container 408 retrieves the encoded features 420 (or a subset thereof) and the trained machine-learning model 403. For example, the inference generation model container 408 selects “all” of the encoded features 420 and selects the “synthetic account prediction v.2” as the trained machine-learning model 403 based on the inference parameters 422.

In turn, the inference generation model container 408 uses the trained machine-learning model 403 to generate the model prediction 426 for the encoded features 420. For example, the trained machine-learning model 403 generates the model prediction 426 by utilizing learned parameters 424 (e.g., tuned parameters from training). To illustrate, the trained machine-learning model 403 uses the learned parameters 424 to predict whether a particular network account is a synthetic account or a real account. Subsequently, the inference generation model container 408 provides the model prediction 426 to the model storage memory 320.

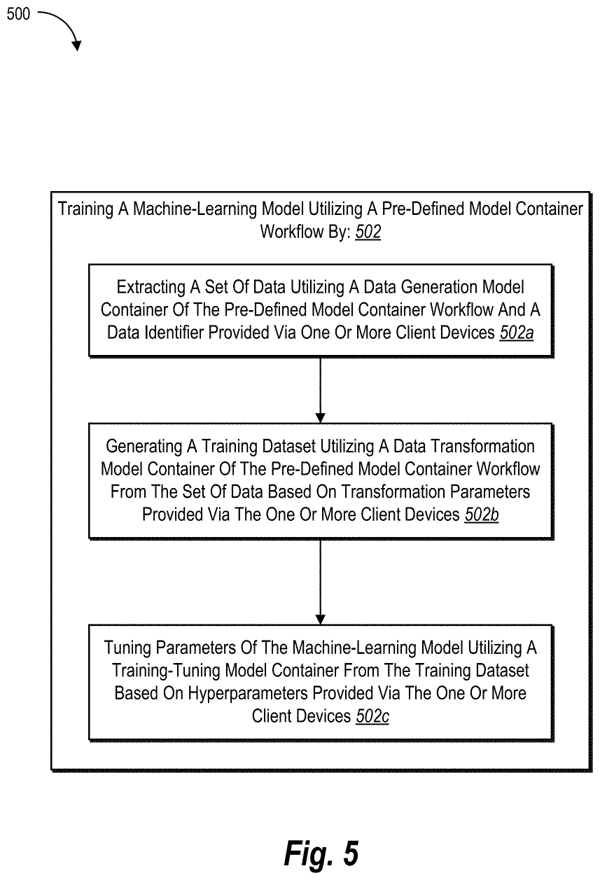

FIGS. 1-4D, the corresponding text, and the examples provide several different systems, methods, techniques, components, and/or devices of the machine-learning platform system 102 in accordance with one or more embodiments. In addition to the above description, one or more embodiments can also be described in terms of flowcharts including acts for accomplishing a particular result. For example, FIG. 5 illustrates a flowchart of a series of acts 500 for training a machine-learning model in accordance with one or more embodiments. The machine-learning platform system 102 may perform one or more acts of the series of acts 500 in addition to or alternatively to one or more acts described in conjunction with other figures. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer-readable medium can comprise instructions that, when executed by one or more processors, cause a computing device to perform the acts of FIG. 5. In some embodiments, a system can perform the acts of FIG. 5.

As shown in FIG. 5, the series of acts 500 includes an act 502 of training a machine-learning model utilizing a pre-defined model container workflow.

In particular, the act 502 comprises an act 502a of extracting a set of data utilizing a data generation model container of the pre-defined model container workflow and a data identifier provided via one or more client devices. In one or more embodiments, extracting the set of data comprises utilizing the data generation model container by executing queries to retrieve digital information from a third-party software platform.

The act 502 further comprises an act 502b of generating a training dataset utilizing a data transformation model container of the pre-defined model container workflow from the set of data based on transformation parameters provided via the one or more client devices. In one or more embodiments, generating the training dataset comprises executing computer-executable instructions within the data transformation model container to convert the set of data into a predetermined data format according to the transformation parameters.

Additionally, the act 502 includes an act 502c of tuning parameters of the machine-learning model utilizing a training-tuning model container from the training dataset based on hyperparameters provided via the one or more client devices. In one or more embodiments, tuning the parameters of the machine-learning model comprises utilizing the training-tuning model container to: generate, for the training dataset, training predictions utilizing the hyperparameters provided via the one or more client devices; and modify one or more learned parameters of the machine-learning model based on a comparison between ground truth data and the training predictions.

It is understood that the outlined acts in the series of acts 500 are only provided as examples, and some of the acts may be optional, combined into fewer acts, or expanded into additional acts without detracting from the essence of the disclosed embodiments. Additionally, the series of acts 500 described herein may be repeated or performed in parallel with one another or in parallel with different instances of the same or similar acts. As an example of an additional act not shown in FIG. 5, act(s) in the series of acts 500 may include an act of: generating a test dataset utilizing the data generation model container of the pre-defined model container workflow from the set of data based on the transformation parameters provided via the one or more client devices; and determining, based on the test dataset, a machine-learning testing metric of the machine-learning model utilizing an evaluation model container of the pre-defined model container workflow based on testing parameters provided via the one or more client devices.

As another example of an additional act not shown in FIG. 5, act(s) in the series of acts 500 may include an act of registering, utilizing a registration model container of the pre-defined model container workflow, a trained version of the machine-learning model with a model storage memory.

As a further example of an additional act not shown in FIG. 5, act(s) in the series of acts 500 may include an act of generating, utilizing a statistics generation model container of the pre-defined model container workflow, feature statistics for values of the training dataset.

In still another example of an additional act not shown in FIG. 5, act(s) in the series of acts 500 may include an act of utilizing a pre-defined inference model container workflow comprising a feature generation model container, a feature transformation model container, and an inference generation model container to generate a prediction from the machine-learning model.

Additionally, another example of an additional act not shown in FIG. 5 includes act(s) in the series of acts 500 of generating a prediction from the machine-learning model by: extracting inference data features utilizing the feature generation model container of the pre-defined inference model container workflow utilizing feature identifiers provided via the one or more client devices; generating encoded features from the inference data features utilizing the feature transformation model container of the pre-defined inference model container workflow; and generating the prediction for the encoded features utilizing the inference generation model container of the pre-defined inference model container workflow and the parameters of the machine-learning model tuned utilizing the training-tuning model container.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates, in block diagram form, an exemplary computing device 600 (e.g., the client device(s) 110a-110c, the third-party server(s) 114, and/or the server(s) 106) that may be configured to perform one or more of the processes described above. As shown by FIG. 6, the computing device can comprise a processor 602, memory 604, a storage device 606, an I/O interface 608, and a communication interface 610. In certain embodiments, the computing device 600 can include fewer or more components than those shown in FIG. 6. Components of computing device 600 shown in FIG. 6 will now be described in additional detail.

In particular embodiments, processor(s) 602 includes hardware for executing instructions, such as those making up a computer program. As an example, and not by way of limitation, to execute instructions, processor(s) 602 may retrieve (or fetch) the instructions from an internal register, an internal cache, memory 604, or a storage device 606 and decode and execute them.

The computing device 600 includes memory 604, which is coupled to the processor(s) 602. The memory 604 may be used for storing data, metadata, and programs for execution by the processor(s). The memory 604 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 604 may be internal or distributed memory.

The computing device 600 includes a storage device 606 includes storage for storing data or instructions. As an example, and not by way of limitation, storage device 606 can comprise a non-transitory storage medium described above. The storage device 606 may include a hard disk drive (“HDD”), flash memory, a Universal Serial Bus (“USB”) drive or a combination of these or other storage devices.

The computing device 600 also includes one or more input or output interface 608 (or “I/O interface 608”), which are provided to allow a user (e.g., requester or provider) to provide input to (such as user strokes), receive output from, and otherwise transfer data to and from the computing device 600. The I/O interface 608 may include a mouse, keypad or a keyboard, a touch screen, camera, optical scanner, network interface, modem, other known I/O devices or a combination of such I/O interface 608. The touch screen may be activated with a stylus or a finger.

The I/O interface 608 may include one or more devices for presenting output to a user, including, but not limited to, a graphics engine, a display (e.g., a display screen), one or more output providers (e.g., display providers), one or more audio speakers, and one or more audio providers. In certain embodiments, interface 608 is configured to provide graphical data to a display for presentation to a user. The graphical data may be representative of one or more graphical user interfaces and/or any other graphical content as may serve a particular implementation.

The computing device 600 can further include a communication interface 610. The communication interface 610 can include hardware, software, or both. The communication interface 610 can provide one or more interfaces for communication (such as, for example, packet-based communication) between the computing device and one or more other computing devices 600 or one or more networks. As an example, and not by way of limitation, communication interface 610 may include a network interface controller (“NIC”) or network adapter for communicating with an Ethernet or other wire-based network or a wireless NIC (“WNIC”) or wireless adapter for communicating with a wireless network, such as a WI-FI. The computing device 600 can further include a bus 612. The bus 612 can comprise hardware, software, or both that connects components of computing device 600 to each other.

FIG. 7 illustrates an example network environment 700 of the inter-network facilitation system 104. The network environment 700 includes a client device 706 (e.g., client device 110a-110c), an inter-network facilitation system 104, and a third-party system 708 connected to each other by a network 704. Although FIG. 7 illustrates a particular arrangement of the client device 706, the inter-network facilitation system 104, the third-party system 708, and the network 704, this disclosure contemplates any suitable arrangement of client device 706, the inter-network facilitation system 104, the third-party system 708, and the network 704. As an example, and not by way of limitation, two or more of client device 706, the inter-network facilitation system 104, and the third-party system 708 communicate directly, bypassing network 704. As another example, two or more of client device 706, the inter-network facilitation system 104, and the third-party system 708 may be physically or logically co-located with each other in whole or in part.

Moreover, although FIG. 7 illustrates a particular number of client devices 706, inter-network facilitation systems 104, third-party systems 708, and networks 704, this disclosure contemplates any suitable number of client devices 706, inter-network facilitation system 104, third-party systems 708, and networks 704. As an example, and not by way of limitation, network environment 700 may include multiple client device 706, inter-network facilitation system 104, third-party systems 708, and/or networks 704.

This disclosure contemplates any suitable network 704. As an example, and not by way of limitation, one or more portions of network 704 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 704 may include one or more networks 704.

Links may connect client device 706, machine-learning platform system 102, and third-party system 708 to network 704 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, the client device 706 may be an electronic device including hardware, software, or embedded logic components or a combination of two or more such components and capable of carrying out the appropriate functionalities implemented or supported by client device 706. As an example, and not by way of limitation, a client device 706 may include any of the computing devices discussed above in relation to FIG. 6. A client device 706 may enable a network user at the client device 706 to access network 704. A client device 706 may enable its user to communicate with other users at other client devices 706.

In particular embodiments, the client device 706 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 706 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 706 one or more Hyper Text Markup Language (“HTML”) files responsive to the HTTP request. The client device 706 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 704) to link the third-party-system 708. For example, the inter-network facilitation system 104 may receive authentication credentials from a user to link a third-party system 708 such as an online bank account, credit account, debit account, or other financial account to a user account within the inter-network facilitation system 104. The inter-network facilitation system 104 can subsequently communicate with the third-party system 708 to detect or identify balances, transactions, withdrawal, transfers, deposits, credits, debits, or other transaction types associated with the third-party system 708. The inter-network facilitation system 104 can further provide the aforementioned or other financial information associated with the third-party system 708 for display via the client device 706. In some cases, the inter-network facilitation system 104 links more than one third-party system 708, receiving account information for accounts associated with each respective third-party system 708 and performing operations or transactions between the different systems via authorized network connections.

In particular embodiments, the inter-network facilitation system 104 may interface between an online banking system and a credit processing system via the network 704. For example, the inter-network facilitation system 104 can provide access to a bank account of a third-party system 708 and linked to a user account within the inter-network facilitation system 104. Indeed, the inter-network facilitation system 104 can facilitate access to, and transactions to and from, the bank account of the third-party system 708 via a client application of the inter-network facilitation system 104 on the client device 706. The inter-network facilitation system 104 can also communicate with a credit processing system, an ATM system, and/or other financial systems (e.g., via the network 704) to authorize and process credit charges to a credit account, perform ATM transactions, perform transfers (or other transactions) across accounts of different third-party systems 708, and to present corresponding information via the client device 706.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 708), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 700 either directly or via network 704. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 706, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 704.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 706. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 706. Information may be pushed to a client device 706 as notifications, or information may be pulled from client device 706 responsive to a request received from client device 706. Authorization servers may be used to enforce one or more privacy settings of the users of the inter-network facilitation system 104. A privacy setting of a user determines how particular information associated with a user can be shared. The authorization server may allow users to opt into or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 706 associated with users.

In addition, the third-party system 708 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 704. A third-party system 708 can communicate with the inter-network facilitation system 104 to provide financial information pertaining to balances, transactions, and other information, whereupon the inter-network facilitation system 104 can provide corresponding information for display via the client device 706. In particular embodiments, a third-party system 708 communicates with the inter-network facilitation system 104 to update account balances, transaction histories, credit usage, and other internal information of the inter-network facilitation system 104 and/or the third-party system 708 based on user interaction with the inter-network facilitation system 104 (e.g., via the client device 706). Indeed, the inter-network facilitation system 104 can synchronize information across one or more third-party systems 708 to reflect accurate account information (e.g., balances, transactions, etc.) across one or more networked systems, including instances where a transaction (e.g., a transfer) from one third-party system 708 affects another third-party system 708.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium comprising instructions that, when executed by at least one processor, cause a computing device to train a machine-learning model utilizing a pre-defined model container workflow by:
extracting a set of data utilizing a data generation model container of the pre-defined model container workflow and a data identifier provided via one or more client devices;
generating a training dataset utilizing a data transformation model container of the pre-defined model container workflow from the set of data based on transformation parameters provided via the one or more client devices; and
tuning parameters of the machine-learning model utilizing a training-tuning model container from the training dataset based on hyperparameters provided via the one or more client devices.

2. The non-transitory computer-readable medium of claim 1, further comprising instructions that, when executed by the at least one processor, cause the computing device to extract the set of data utilizing the data generation model container by executing queries to retrieve digital information from a third-party software platform.

3. The non-transitory computer-readable medium of claim 1, further comprising instructions that, when executed by the at least one processor, cause the computing device to generate the training dataset by executing computer-executable instructions within the data transformation model container to convert the set of data into a predetermined data format according to the transformation parameters.

4. The non-transitory computer-readable medium of claim 1, further comprising instructions that, when executed by the at least one processor, cause the computing device to tune the parameters of the machine-learning model by utilizing the training-tuning model container to:
generate, for the training dataset, training predictions utilizing the hyperparameters provided via the one or more client devices; and
modify one or more learned parameters of the machine-learning model based on a comparison between ground truth data and the training predictions.

5. The non-transitory computer-readable medium of claim 1, further comprising instructions that, when executed by the at least one processor, cause the computing device to:
generate a test dataset utilizing the data generation model container of the pre-defined model container workflow from the set of data based on the transformation parameters provided via the one or more client devices; and
determine, based on the test dataset, a machine-learning testing metric of the machine-learning model utilizing an evaluation model container of the pre-defined model container workflow based on testing parameters provided via the one or more client devices.

6. The non-transitory computer-readable medium of claim 1, further comprising instructions that, when executed by the at least one processor, cause the computing device to register, utilizing a registration model container of the pre-defined model container workflow, a trained version of the machine-learning model with a model storage memory.

7. The non-transitory computer-readable medium of claim 1, further comprising instructions that, when executed by the at least one processor, cause the computing device to generate, utilizing a statistics generation model container of the pre-defined model container workflow, feature statistics for values of the training dataset.

8. The non-transitory computer-readable medium of claim 1, further comprising instructions that, when executed by the at least one processor, cause the computing device to utilize a pre-defined inference model container workflow comprising a feature generation model container, a feature transformation model container, and an inference generation model container to generate a prediction from the machine-learning model.

9. The non-transitory computer-readable medium of claim 8, further comprising instructions that, when executed by the at least one processor, cause the computing device to generate a prediction from the machine-learning model by:
extracting inference data features utilizing the feature generation model container of the pre-defined inference model container workflow utilizing feature identifiers provided via the one or more client devices;
generating encoded features from the inference data features utilizing the feature transformation model container of the pre-defined inference model container workflow; and
generating the prediction for the encoded features utilizing the inference generation model container of the pre-defined inference model container workflow and the parameters of the machine-learning model tuned utilizing the training-tuning model container.

10. A system comprising:
at least one processor; and
at least one non-transitory computer-readable storage medium storing instructions that, when executed by the at least one processor, cause the system to train a machine-learning model utilizing a pre-defined model container workflow by:
extracting a set of data utilizing a data generation model container of the pre-defined model container workflow and a data identifier provided via one or more client devices;
generating a training dataset utilizing a data transformation model container of the pre-defined model container workflow from the set of data based on transformation parameters provided via the one or more client devices; and
tuning parameters of the machine-learning model utilizing a training-tuning model container from the training dataset based on hyperparameters provided via the one or more client devices.

11. The system of claim 10, further comprising instructions that, when executed by the at least one processor, cause the system to extract the set of data utilizing the data generation model container by executing queries to retrieve digital information from a third-party software platform.

12. The system of claim 10, further comprising instructions that, when executed by the at least one processor, cause the system to generate the training dataset by executing computer-executable instructions within the data transformation model container to convert the set of data into a predetermined data format according to the transformation parameters.

13. The system of claim 10, further comprising instructions that, when executed by the at least one processor, cause the system to tune the parameters of the machine-learning model by utilizing the training-tuning model container to:
generate, for the training dataset, training predictions utilizing the hyperparameters provided via the one or more client devices; and
modify one or more learned parameters of the machine-learning model based on a comparison between ground truth data and the training predictions.

14. The system of claim 10, further comprising instructions that, when executed by the at least one processor, cause the system to:
generate a test dataset utilizing the data generation model container of the pre-defined model container workflow from the set of data based on the transformation parameters provided via the one or more client devices; and
determine, based on the test dataset, a machine-learning testing metric of the machine-learning model utilizing an evaluation model container of the pre-defined model container workflow based on testing parameters provided via the one or more client devices.

15. The system of claim 10, further comprising instructions that, when executed by the at least one processor, cause the system to register, utilizing a registration container of the pre-defined model container workflow, a trained version of the machine-learning model with a model storage memory.

16. The system of claim 10, further comprising instructions that, when executed by the at least one processor, cause the system to generate, utilizing a statistics generation container of the pre-defined model container workflow, feature statistics for values of the training dataset.

17. A computer-implemented method comprising:
training a machine-learning model utilizing a pre-defined model container workflow by:
extracting a set of data utilizing a data generation model container of the pre-defined model container workflow and a data identifier provided via one or more client devices;
generating a training dataset utilizing a data transformation model container of the pre-defined model container workflow from the set of data based on transformation parameters provided via the one or more client devices; and
tuning parameters of the machine-learning model utilizing a training-tuning model container from the training dataset based on hyperparameters provided via the one or more client devices.

18. The computer-implemented method of claim 17, wherein extracting the set of data utilizing the data generation model container comprises executing queries to retrieve digital information from a third-party software platform.

19. The computer-implemented method of claim 17, wherein generating the training dataset comprises executing computer-executable instructions within the data transformation model container to convert the set of data into a predetermined data format according to the transformation parameters.

20. The computer-implemented method of claim 17, wherein tuning the parameters of the machine-learning model comprise utilizing the training-tuning model container to:
generate, for the training dataset, training predictions utilizing the hyperparameters provided via the one or more client devices; and
modify one or more learned parameters of the machine-learning model based on a comparison between ground truth data and the training predictions.
